(19) United States
(12) Patent Application Publication
(10) Pub. No.: US 2004/0095645 A1
(43) Pub. Date: May 20, 2004

(54) Multi-layer thin film optical filter arrangement

(75) Inventors: Samuel F. Pellicori, Santa Barbara, CA (US); Scott Berrum, Manhattan Beach, CA (US); Christopher Donnelly, Manhattan Beach, CA (US)

Correspondence Address: JONES DAY, 555 WEST FIFTH STREET, SUITE 4600, LOS ANGELES, CA, 90013-1025, US

(73) Assignee: Jax Holdings, Inc., Hawthorne, CA

(21) Appl. No.: 10/602,027

(22) Filed: Jun. 23, 2003

Related U.S. Application Data
(62) Division of application No. 09/771,444, filed on Jan. 25, 2001, now abandoned.

(51) Int. Cl. G02B 1/10

(52) U.S. Cl. 359/584

(57) ABSTRACT

An improved multi-layer optical filter arrangement having spatially and spectrally differential reflection characteristics on one side and substantially uniform transmission characteristics over a band of at least 250 nm in the optical spectrum is provided. The filter arrangement includes two optical thin film stacks disposed on the surface of a substrate in a side by side relationship. Each of the thin film stacks includes two metal layers and a dielectric layer interposed between the two metal layers. At least one of the stacks includes an additional dielectric layer deposited thereon. In addition, one or more matching dielectric layers may be interposed between the substrate and first metal layer of each of the stacks to reduce reverse reflection of the filter arrangement. A semi-continuous process for producing the filter arrangements on flexible films is also included.

This application is a divisional of U.S. patent application Ser. No. 09/771,444, filed Jan. 25, 2001, which is hereby incorporated by reference as if fully set forth herein.

### BACKGROUND OF THE INVENTION

1. Field of the Invention

The field of the present invention relates to thin film optical filters, and more specifically thin film optical filter arrangements having differential reflection and substantially uniform transmission characteristics over a defined portion of the electromagnetic spectrum.

2. Background

U.S. Pat. No. 5,731,898, incorporated herein by reference, discloses an optical filter arrangement which when viewed from a first reflecting side reflects light in a predetermined pattern, yet when viewed from the reverse side of the filter, the pattern is substantially visually imperceptible. The basic filter arrangement disclosed in the '898 patent includes a metal and a dielectric layer deposited on one side of a substrate, such as glass. Arranged thusly, the filter arrangement has two sides: a reflecting side, which in the embodiments illustrated in the '898 patent is the side upon which the thin films are deposited on the substrate, and a reverse side, or the side of the substrate opposite the reflecting side.

To generate the predetermined pattern, the reflecting side of the filter arrangements disclosed in the '898 patent include two adjacent reflecting areas, each of which is constructed to reflect a different predetermined wavelength band of visible light, with the wavelength band reflected determining the perceived color of the reflection. In this manner, the two reflecting areas form a discernable colored pattern, which includes an image and a background, when viewed in reflection from the reflecting side.

The particular wavelength band of visible light reflected by each area is determined by the nature of the optical coating underlying the first and second reflecting areas. For example, the '898 patent teaches that if the optical coating in the reflecting area consists of just a thin film of chromium metal, then the reflecting area will reflect a spectrally neutral color band in the visible spectrum. In comparison, the '898 patent teaches that if the optical coating in the reflecting area is composed of a dielectric thin film, such as SiO, deposited on top of the chromium in a thickness corresponding to approximately one quarter-wavelength optical thickness (QWOT) in the visible spectrum, color is produced through destructive interference. As a result, the reflectance becomes asymmetric and color is perceived.

The first and second reflecting areas of the filter arrangement of the '898 patent are therefore composed of either a metal layer or the metal layer having a dielectric coating deposited thereon. If a reflecting area is composed of just the metal thin film, then the reflected color is spectrally neutral. If, on the other hand, a reflecting area is composed of the metal layer and further has a thin film of dielectric deposited thereon, then the reflected color is determined by the thickness of the dielectric layer. Because the exact nature of the optical coating is different in each of the reflecting areas, a pattern is perceived on the reflecting side of the filter arrangement.

The optical filter arrangements disclosed in the '898 patent tend to exhibit colors that are not as brilliant and do not have as high of contrast as may be desired for certain applications. This is because the colors produced by the QWOT coatings disclosed in the '898 patent tend to have a wide spectral band, and consequently are flat and dull.

Because colors perceived from the reflecting areas are partially removed from the visible light transmitted through the filter arrangement, a means for balancing the transmitted light is required to achieve color balance. In the absence of such means, the visible light transmitted through the first reflecting area will have a different spectral makeup than visible light transmitted through the second reflecting area and the pattern would be visible in transmission. In order to compensate for this difference, the '898 patent teaches two different means for achieving color balance in the visible light transmitted through the first and second reflecting areas.

The first means taught in the '898 patent for balancing the transmitted light involves varying the thickness of the metal thin film between the dielectric thin films forming the reflecting areas and the substrate. Visible light passing through the reflecting areas is partially absorbed by the metallic thin film, with the amount absorbed being dependent upon the thickness of the metallic thin film. As a result, by varying the thickness sufficient transmission balance may be achieved so that the pattern is substantially visually imperceptible to the viewer from the backside. However, such an approach can be self-limiting in application because the metal layer thickness has to be maintained within a small range in order to avoid high rear reflections, which can lead to unacceptable glare for certain applications where there may be high back lighting conditions, for example windscreens for automobiles or architectural glass. Further, the thickness of the metal layer employed in the '898 patent tends to produce filter arrangements having less than 30% transmission. This is acceptable for sunglasses, but is generally too low for windshields, helmet visors, and other optics where transmissions of 40% or more are desirable. While reducing the thickness of the metallic thin film beneath the first and second reflecting areas to allow greater transmittance would increase transmission, it would have the concomitant effect of making the pattern more visible when viewed from the reverse side, thus defeating the purpose of the optical filter arrangement.

The second transmission balancing method taught by the '898 patent is accomplished by depositing the optical thin films on a filter substrate having approximately 50% transmission. In addition, the color of the substrate may be chosen to further reduce any color imbalance of the transmitted light through the substrate. Using the above methods in combination, the '898 patent teaches that a transmittance of between 10% and 20% can be achieved, which is noted as an acceptable range of transmission for sunglasses. For certain applications, however, an optical filter arrangement may be desired having similar transmission balancing properties taught by the '898 patent, but with higher transmission rates. In such other applications, higher transmission rates may be critical for safety or other reasons.

The batch coating process described in the '898 patent for manufacturing optical filter arrangements tends to be slow in practice. Nor is it suitable for the production of large format filter arrangements on a commercially viable basis.

The slowness of the production process arises from limitations in the methods used. In general, the '898 patent discloses a batch-type process, which naturally limits the number of filter arrangements that can be coated at any one time to the number of filter arrangements that may be fit into the coating chamber. As the size of the chamber grows, however, the down time between coating process will grow as well, as it will take additional time to pump the coating chamber down to pressure levels acceptable for the deposition of thin films in a controllable manner. As a result, achieving large economies of scale is not simply a matter of scaling up a small operation. Therefore, the quantities of optical filter arrangements yielded from the batch-type process described in the '898 patent is not well suited to provide large quantities of product to a mass market. Rather, the batch-type coating process, naturally lends itself towards smaller production quantities.

The size of the optical filter arrangement is also naturally limited by the size of the coating chamber. Indeed, it has been found that the standard available evaporation and sputter batch-coating chambers are generally of insufficient size to permit the production of filter arrangements for large format applications in a satisfactory manner. Merely designing or locating larger coating chambers is not a satisfactory approach either. The deposition of a multi-layer coating onto a rigid substrate is accomplished at substantial risk. The coating of optical thin films requires tight process control. Further, as the size of the substrate increases, the potential for noticeable imperfections over the surface of the substrate increases. If an error occurs in the coating process, the substrate is lost, resulting in substantial expense. As a result of these impediments, a wide variety of large format applications that could be satisfied if a suitable manufacturing process were available has gone unfulfilled.

In view of the foregoing, a need exists for an optical filter arrangement having an improved method of balancing transmitted light in the optical spectrum between the first and second reflecting areas. Such an improved optical filter arrangement would be especially desirable if it permitted colored patterns having more brilliant and high contrast colors to be produced. It would also be desirable if an improved optical filter arrangement could be provided that permitted designs with greater transmission rates for visible light, thus allowing its use in a wider variety of applications. A filter arrangement possessing one or more of the foregoing features and having reduced glare on the reverse side of the filter arrangement would also be desirable.

A further need exists for an improved method of manufacturing multi-layer thin film optical filter arrangements that would allow for the production of not only large format filter arrangements, but also smaller format filter arrangements on a larger production basis.

Accordingly, an object of one aspect of the present invention is to provide an improved optical filter arrangement that satisfies one or more of the foregoing needs, as well as possesses other desirable features. An object of another aspect of the present invention is to provide an improved manufacturing process for multi-layer thin film optical filter arrangements that overcomes one or more of the deficiencies in existing methods.

### SUMMARY OF THE INVENTION

A first aspect of the present invention is directed to an improved multi-layer optical filter arrangement. The filter arrangement has spatially and spectrally differential reflection characteristics on one side and substantially uniform transmission characteristics over a band of at least 250 nm in the optical spectrum. The filter arrangement includes two optical thin film stacks disposed on the surface of a substrate in a contiguous side by side relationship. Each of the thin film stacks includes two common metal layers and a common dielectric layer interposed between the two metal layers. At least one of the stacks includes an additional dielectric layer deposited thereon. In addition, one or more common matching dielectric layers may be interposed between the substrate and first metal layer of each of the stacks to reduce reverse reflection of the filter arrangement.

Thus, according to one embodiment of the invention the filter arrangement comprises a substrate that is at least semi-transparent over the majority of the band, a first stack of optical thin films deposited on the substrate, and a second stack of optical thin films deposited on the substrate in a contiguous side by side relationship with the first stack. The first stack comprises two metal layers and a dielectric layer interposed therebetween. The second stack also includes two metal layers and a dielectric layer interposed therebetween, the two metal layers and dielectric layer of the second stack being mere extensions of the layers in the first stack. The second stack, however, further includes a second dielectric layer deposited thereon. As a result, the first and second stacks reflect substantially different spectrums of light within the band from a reflecting side of the filter arrangement. However, the filter arrangements according to the present invention also have substantially uniform transmission characteristics within the band.

Preferably the band includes at least a portion of the near UV spectrum, the visible spectrum, or the near infrared spectrum. In particularly preferred embodiments of the invention, the filter arrangement is designed to operate over the visible spectrum between 480 nm and 630 nm, and more preferably between 400 nm and 700 nm. When the filter arrangement is designed to operate in the visible range, the first and second stacks will reflect a spatially colored pattern that is visually perceptible from a reflecting side of the filter arrangement. On the other hand, because transmission through the filter arrangements of the present invention is substantially uniform through both the first and second stacks, the reflected pattern will be substantially visually imperceptible when viewed from the opposite side of the arrangement.

The shape of the reflected pattern will depend on the shape of the respective areas of the substrate covered with the first and second stacks, but in general the “pattern” may take the form of any logo, design, picture, advertisement, device, or the like.

Sandwiching the dielectric layer between the two metal layers in the first and second stacks improves the ability to display brilliant and high contrast colors in the reflected pattern and the total amount of light that is transmitted through the filter arrangement. Essentially, these three layers comprise a form of optical cavity in which light is reflected between the metallic layers multiple times. With each reflection, the metallic layers partially absorb the light. In this manner, color and intensity balance may be achieved while allowing more brilliant and high contrast colors to be produced on the reflecting side and greater transmission rates through the filter arrangement.

Alternative embodiments of the improved optical filter arrangement comprise strategically adding additional dielectric or metallic layers. Additional layers permit an even wider range of brilliant and high contrast colors and reduced reverse reflection while maintaining the improved transmission rates and color balancing.

A second aspect of the present invention is directed to an improved method of manufacturing multi-layer thin film optical filter arrangements. The method includes forming one or more optical filter arrangements on a roll of flexible film substrate that is at least 0.3 m wide. Pursuant to the method a thin film base stack is deposited on a surface of the film substrate over a substantial majority of its length using a web coater. A removable mask layer is then printed over a portion of the base stack using a wide format printer or other means. At least one additional thin film layer is then deposited over the base stack and mask layer using the web coater, following which the mask layer is removed. The method allows for the production of not only custom large format filter arrangements, but also a plurality of smaller format filter arrangements on a large commercial production basis.

Further objects, desirable features, and advantages of the invention will be better understood from the following description considered in connection with accompanying drawings in which various embodiments of the invention are illustrated by way of example. It is to be expressly understood, however, that the drawings are for the purpose of illustration only and are not intended as a definition of the limits of the invention.

### BRIEF DESCRIPTION OF THE DRAWINGS

FIG. 1 is a cross-sectional view through an optical filter arrangement according to the present invention;

FIG. 2 is a chart that correlates desired characteristics of optical filter arrangements according to the present invention with the components of the arrangements;

FIGS. 3, 4 and 5 are graphs illustrating computed reflectance, transmission, and reversere reflectance rates, respectively, as a function of wavelength from 400 nm to 700 nm of an example of the optical filter arrangement of FIG. 1;

FIG. 6 is a chart detailing theoretical calculations regarding an example of the optical filter arrangement of FIG. 1;

FIG. 7 is a cross-sectional view through another optical filter arrangement according to the present invention;

FIGS. 8, 9 and 10 are graphs illustrating computed reflectance, transmission, and reverse reflectance rates, respectively, as a function of wavelength from 400 nm to 700 nm of an example of the optical filter arrangement of FIG. 7;

FIG. 11 is a chart detailing theoretical calculations regarding an example of the optical filter arrangement of FIG. 7;

FIG. 12 is a chart detailing theoretical calculations regarding a second example of the optical filter arrangement of FIG. 7;

FIGS. 13, 14 and 15 are graphs illustrating computed reflectance, transmission, and reverse reflectance rates, respectively, as a function of wavelength from 400 nm to 700 nm of a second example of the optical filter arrangement of FIG. 7;

FIG. 16 is a cross-sectional view though still another embodiment of an optical filter arrangement according to the present invention;

FIGS. 17, 18 and 19 are graphs illustrating computed reflectance, transmission, and reverse reflectance rates, respectively, as a function of wavelength from 400 nm to 700 nm of an example of the optical filter arrangement of FIG. 16;

FIG. 20 is a chart detailing theoretical calculations regarding an example of the optical filter arrangement of FIG. 16;

FIG. 21 is a cross sectional view through yet another embodiment of an optical filter arrangement according to the present invention;

FIG. 22 is a cross sectional view through another embodiment of an optical filter arrangement according to the present invention;

FIG. 23 is a cross sectional view through still another embodiment of an optical filter arrangement according to the present invention;

FIGS. 24, 25 and 26 are graphs illustrating computed reflectance, transmission, and reverse reflectance rates, respectively, as a function of wavelength from 400 nm to 700 nm of an example of the optical filter arrangement of FIG. 21;

FIG. 27 is a chart detailing theoretical calculations regarding an example of the optical filter arrangement of FIG. 21;

FIG. 28 is a chart detailing theoretical calculations regarding an example of the optical filter arrangement of FIG. 22;

FIGS. 29, 30 and 31 are graphs illustrating computed reflectance, transmission, and reverse reflectance rates, respectively, as a function of wavelength from 400 nm to 700 nm of an example of the optical filter arrangement of FIG. 22;

FIGS. 32, 33 and 34 are graphs illustrating computed reflectance, transmission, and reverse reflectance rates, respectively, as a function of wavelength from 400 nm to 700 nm of an example of the optical filter arrangement of FIG. 23;

FIG. 35 illustrates still another embodiment of an optical filter arrangement according to the present invention;

FIGS. 36, 37 and 38 are graphs illustrating computed reflectance, transmission, and reverse reflectance rates, respectively, as a function of wavelength from 400 nm to 700 nm of a second example of the optical filter arrangement of FIG. 23;

FIG. 39 is a chart detailing theoretical calculations regarding a second example of the optical filter arrangement of FIG. 23;

FIG. 40 is a schematic illustration of a prior art coating machine that may be used in manufacturing optical filter arrangements of the present invention on rolls of flexible film substrates.

### DETAILED DESCRIPTION OF THE PREFERRED EMBODIMENTS

Thin films may be deposited on a substrate using one of several different methods that are well known in the art such as physical vapor deposition (PVD), ion-assisted PVD, chemical vapor deposition, evaporation, sputtering, magnetron sputtering, and chemical spraying or dipping processes. When multiple layers of thin films are deposited upon a substrate, the multiple layers are commonly referred to as a stack. Each stack has certain performance characteristics which are determined by several factors such as the number of layers, the thickness of each layer individually and in combination with other adjacent layers, the composition of each layer, the order of the layers, and the entrance and exit mediums of the stack. These factors are themselves determined by the reflectance, transmission, absorption, and phase variance effects of each individual layer and the combination of layers that form the stack and operate on the principle of controlled constructive and destructive interference of wavelength bands. For this reason, stack designs with slight variances in the above factors typically display different optical characteristics.

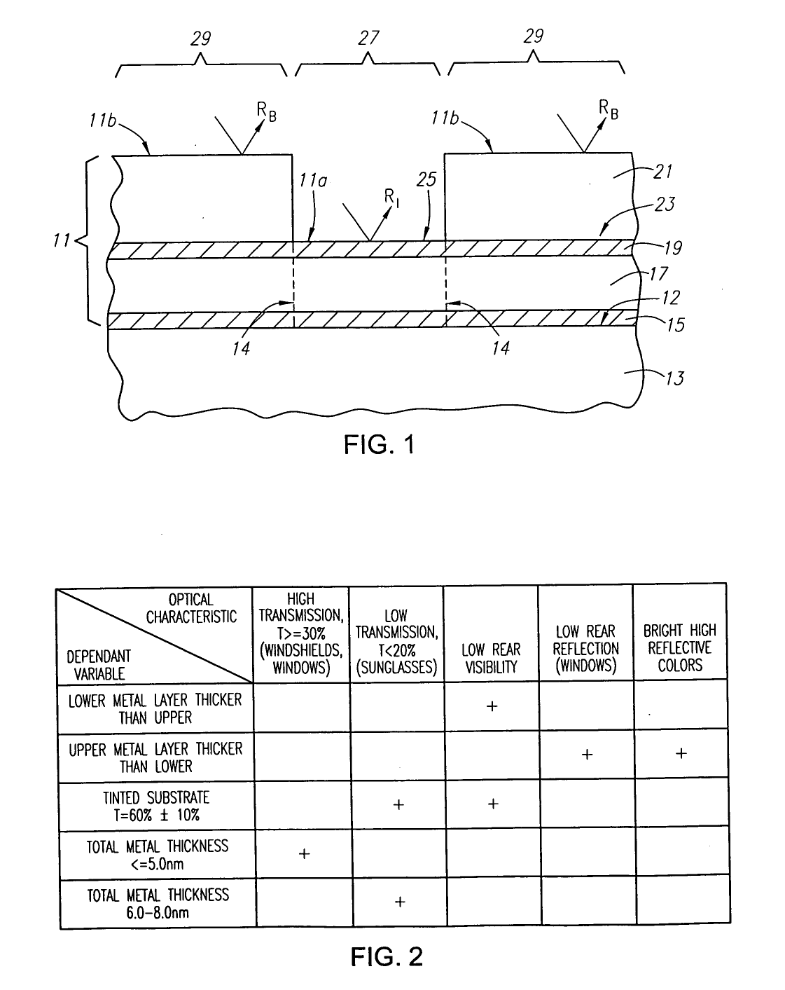

A cross-sectional view through a multi-layer filter arrangement according to a first embodiment of the present invention is shown in FIG. 1. The optical filter arrangements of the present invention are designed to possess spatially and spectrally differential reflection characteristics and substantially uniform transmission characteristics over a band of at least 250 nm, and preferably a band of at least 300 nm, in the optical spectrum. The differential spatial and spectral reflection properties of the filter arrangement can be patterned to produce a wide variety of identifiable images, logos, designs, and pictures useful for advertising, security, identification purposes and the like,

It will be appreciated by those skilled in the art that for those filter arrangements designed to produce spectrally differential reflection in the ultraviolet or infrared regions of the optical spectrum, suitable detector equipment will be required to view the reflected pattern. Such filter arrangements, however, are particularly well suited for security and anti-counterfeiting applications, for example in connection with the CD and DVD industries.

While the filter arrangements of the present invention exhibit spatially and spectrally differential reflection characteristics over the predetermined band, the filter arrangements according to the present invention also exhibit substantially uniform transmission characteristics over the same band. As a result, when the filter arrangement is viewed in transmission from a side opposite of the reflecting side, there is substantially no difference in the spatial transmission qualities of the filter arrangement. For filter arrangements designed to operate in the visible spectrum, this means that the pattern will exhibit little or no perceptible contrast to the viewer when the filter arrangement is viewed from the side opposite the reflecting side.

The filter arrangement of FIG. 1 comprises four basic thin film layers deposited on a surface 12 of substrate 13. Generally, substrate 13 is a glass or plastic that is at least semi-transparent over the majority of the band for which the filter arrangement is designed. Preferably, however, substrate 13 is transparent and color neutral over the entire spectral band for which it is designed so that it does not substantially absorb one wavelength of light more than another within the band. Substrate 13 may be a rigid glass or plastic or it may comprise a flexible substrate, such as a flexible polymer film. Suitable polymers for producing flexible substrates and flexible film substrates include, for example, polyesters, PET, polycarbonate, acrylic, cellulose triacetate, as well as others.

The four basic thin film layers that form stack I I may be conveniently designated the first through the fourth, in consecutive numerical order, beginning with the layer closest to the substrate 13. Thus, starting from the substrate 13 and proceeding towards the outer layers, the stack 11 includes a first metal layer 15 (first layer), a first dielectric layer 17 (second layer), a second metal layer 19 (third layer) comprising at least a primary and a secondary area 23, 25, and a second dielectric layer 21 (fourth layer) which is disposed upon the primary area 23 of the second metal layer 19.

The semi-transparent metal layers 15, 19 are preferably spectrally neutral in the spectral band for which the filter arrangement is designed. In addition, for ease of production, the metal(s) used to form metal layers 15, 19 preferably have an extinction coefficient (k) of less than 4. Examples of semi-transparent metals suitable for use in the optical filter arrangements of the present invention include chromium, nichrome, inconel, molybdenum, nickel, tungsten, rhodium, titanium, and vanadium. Non-neutral metals may also be used in certain implementations to better emphasize or de-emphasize a particular portion of the optical spectrum. Cermets may also be used as one of metal layers 15, 19, or as an additional absorption layer. The advantage of these materials is that they tend to be more transparent than metals, while also being an absorbing material with very high indexes of refraction.

A wide variety of dielectric materials may be used for layers 17 and 21. Preferably, however, the selected dielectric has an index of refraction that is approximately the square root of the real part of the index of refraction of the metal used for layers 15, 19. Dielectrics having an index of refraction near 2, which is approximately the square root of the real part of the index of refraction for the preferred metals, include: silicon monoxide, titanium dioxide, tantalum pentoxide, yttrium oxide, neodymium oxide, niobium oxide, indium tin oxide, indium zinc oxide, zirconium oxide and the like. In addition to metal oxide dielectrics, dielectrics of metal sulfides and metal nitrides may also be used.

As those skilled in the art will appreciate, any dispersion in the optical constants (n and k) for the thin films employed in the stack over the design band of the filter arrangement should be taken into consideration in the modeling and design of the stack 11.

In general, the thickness of metal layer 15 will typically range between approximately 0.8 to 4 nm while the thickness of metal layer 19 will typically range between approximately 1.0 and 7.5 nm. However, for metals having an extinction coefficient of greater than 4, these thickness ranges will tend to decrease. Similarly, for metals having extinction coefficients significantly less than 4, the thickness of the metals used for layers 15, 19 may increase.

The dielectric layer 17 sandwiched between the two metal layers will typically have an optical thickness ranging between about one-quarter and one-half a wavelength for a wavelength at or just below the lower limit of the spectral band for which the optical filter arrangement is designed. However, other thicknesses are also useful as discussed below. The upper dielectric layer 21 preferably has an optical thickness of at least one-eighth of a wavelength for a wavelength at or just below the lower limit of the spectral band for which the optical filter arrangement is designed. Typically, however, the second dielectric layer will have an optical thickness ranging between approximately one-quarter of a wavelength for a wavelength at or slightly below the lower limit of the spectral band for which the filter arrangement is designed to a full wavelength in the middle of the spectral band for which the filter arrangement is designed.

Stack 11 may be conveniently viewed as comprising two separate optical thin film stacks 11a and 11b, where stack 11a includes the first through third layers of stack 11 and stack 11b includes the first through fourth layers of stack 11. Dashed lines 14 generally demarcate the boundary between stacks 11a and 11b.

Viewed in this manner, it is seen that stacks 11a and 11b are deposited in a contiguous side by side relationship on the surface of substrate 13. Further, it can be seen that both stacks 11a and 11b include two common metal layers 15, 19 with a common dielectric layer 17 interposed therebetween. The difference between the two stacks 11a and 11b being that stack 11a includes an additional dielectric layer 21 deposited thereon.

The first stack 11a defines a first reflecting area 27, and the second stack 11b defines a second reflecting area 29. Together, the first and second reflecting areas 27, 29 cause the filter arrangement to exhibit spatially and spectrally differential reflection over its surface in the waveband of interest. As a result, a distinct predetermined pattern is formed when the filter arrangement is observed in reflection from the reflecting side of the substrate 13.

In the embodiment illustrated in FIG. 1, the reflecting side is defined as the side of the substrate upon which the thin films are deposited. However, those skilled in the art will appreciate that constructions in which the reflection side is the opposite side are also possible. Within the pattern created by stacks 11a, 11b, the first reflecting area 27 is considered to form the image of the pattern, while the second reflecting area 29 is considered to form the background. This, however, is an arbitrary design choice and it will be appreciated that the image may be formed by stack 11b and the background may be formed by stack 11a.

The spatial and spectrally differential reflection is created by stacks 11a and 11b, because the first reflecting area 27 is designed to reflect a first spectrum of light within the waveband of interest and the second reflecting area 29 is designed to reflect a substantially different spectrum of light in the waveband of interest.

The composition of the second spectrum is determined by the overall structure of stack 11b. However, it is primarily determined by the thickness of the second dielectric layer 21. Some of the light incident on the second reflecting area 29 is reflected by the upper surface of the second dielectric layer, with the remainder being transmitted through the layer. No light is absorbed by the second dielectric layer 21 because dielectric thin films do not absorb light. The amount of light reflected and transmitted is determined based on the refractive indices of air and the particular dielectric used. A portion of the transmitted light is then reflected off the interface between the second dielectric layer 21 and the second metal layer 19, with the remainder being transmitted into the metal layer. As before, the amount of light reflected and transmitted depends on the refractive indices of the particular dielectric and metal used. The second spectrum therefore is primarily created by selecting a thickness for the second dielectric layer 21 that will result in interference in the waveband of interest between the light reflected from the upper surface of second dielectric layer 21 and the light reflected from the interface between second dielectric layer 21 and the second metal layer 19. As a result, the overall amount of light reflected or transmitted is determined by the optical path difference in the dielectric layer and the phase changes at the interfaces with the metal layer and entrance medium to produce either destructive interference and thus transmission of a bandpass or constructive interference and thus reflection of a complimentary bandpass.

By selecting an appropriate thickness of the second dielectric layer 21, some of the reflected light can be made to constructively interfere, thereby leading to high reflection as viewed from the reflection side, and some light can be made to destructively interfere and partially or completely cancel. For example, if the optical thickness of the dielectric layer is an odd multiple of one-quarter wavelength for a particular wavelength of visible light, then that wavelength will be destructively interfered with. However, if the optical thickness is a multiple of one-half wavelength for a particular wavelength of visible light, then that color will be constructively interfered with. For filter arrangements having the construction illustrated in FIG. 1, constructive interference will also be experienced if dielectric layer 21 has an optical thickness of approximately one-eighth of a quarter wavelength for a wavelength in the visible spectrum. Wavelengths in the reflected spectrum of light that boarder the wavelengths that are targeted to be destructively or constructively interfered with will undergo partial destructive or constructive interference, as the case may be.

When the thickness of the second dielectric layer is such that a particular wavelength is destructively interfered with, typically the reflected spectrum is perceived as a dull color. When the thickness of the second dielectric layer is such that a particular wavelength is constructively interfered with, the reflected spectrum is typically perceived as a brighter color. Therefore, the thickness of the second dielectric layer is preferably one that will cause both constructive and destructive interference in the reflected second spectrum so that greatest brightness in color will be achieved.

Those skilled in the art will appreciate that because metal layer 19 has a complex refractive index, the phase shift caused in the light reflected at the interface between layers 19 and 21 will depend on the thickness of metal layer 19. As a result, the exact optical thickness required for dielectric layer 21 to achieve quarter wavelength destructive interference or half wavelength constructive interference at a desired wavelength may very slightly from the actual quarter or half wavelength optical thickness for the dielectric layer 21. Those skilled in the art, however, can readily take such phase shifts into account when designing filter arrangements according to the present invention. Those skilled in the art will also appreciate that while the foregoing discussion has focussed on visible light that the same principals apply for other portions of the optical spectrum for which filter arrangements of the present invention may be designed.

The composition of the first spectrum of light reflected from stack 11b is primarily determined by the thickness of the second metal layer 19. However, the thickness of the first dielectric layer 17 may also influence the reflected spectrum. The influence of the first dielectric layer 17 on the first reflected spectrum will generally decrease as the thickness of metal layer 19 increases. The thickness of the first dielectric layer 17 has a similar affect on the first spectrum as the previously described second dielectric layer 21 has on the second spectrum in creating an interference pattern. Namely it will cause constructive and destructive interference with light reflected from the air metal interface at the upper surface of layer 19 . Again, however, because the metal thin film layers 15 and 19 have a complex refractive index, these phase shifts need to be taken into account along with the thickness of the dielectric layer to determine which wavelengths will be constructively interfered with and which will be destructively interfered with.

While dielectric layer 17 will effect the spectral composition of the first reflected spectrum to some degree, as described more fully below, the purpose of interposing dielectric layer 17 between metal layers 15 and 19 is to help achieve uniform transmission through stacks 11a and 11b in the spectral region of interest as well as to help reduce reverse reflection in that region.

The other layers in the stack and the substrate may also contribute to the composition of the first and second reflected spectrums. The contribution of these other components, while typically minor, is based on the performance characteristics of each as discussed more fully below.

Sufficient contrast must exist between the light reflected from the background and image areas of the filter arrangement to make the pattern observable when the filter arrangement is viewed in reflection from the reflecting side. To insure adequate contrast, the first and second spectrum reflected by stacks 11a and 11b should be substantially different. The first and second spectrum are considered substantially different for purposes of the present invention if the percentage of reflected light included in the spectrum varies by over 5% over a substantial portion of the waveband for which the filter is designed to operate (e.g. at least 80 nm for a 250 nm wavelength band). Preferably, however, the difference in the percentage of reflected light included in the first spectrum and the percentage of reflected light included in the second spectrum varies by at least 10% over a substantial portion of the design band, and more preferably it varies by at least 15% over a substantial portion of the design band.

The color perceived by an individual viewing the first and second spectrum is dependent upon the composition of the spectrum in relation to the photopic response of the human eye. Thus, when designing a filter arrangement according to the present invention that is intended to produce a visible image, the photopic response of the human eye should be taken into account. Typically, the photopic response of the human eye is shaped like a bell curve running from a wavelength of approximately 400 nm to approximately 700 nm, with a peak at approximately 550 nm. This makes the typical individual more sensitive to color and variations in color around the peak of the curve than near the edges of the curve. Therefore, to achieve maximum perceived color contrast between the first and second spectrum in the visible range, stacks 11a and 11b should be designed to provide high contrast levels within the 480 to 630 nm range and preferably exhibit high contrast levels around 550 nm. In particular, it is preferred that the contrast between the first and second spectrum be at least 0.07 and more preferably at least 0.30, and even more preferably at least 0.40 at 550 nm, where contrast is defined as the absolute value of

(R_{I}−R_{B})/(R_{I}+R_{B})

Stacks 11a and 11b are designed so that when the filter arrangement is observed in transmission from the reverse side, defined as the side opposite the reflecting side, transmission through the two stacks is substantially uniform across the portion of the optical spectrum of interest. As a result, the filter arrangements according to the present invention exhibit spectrally and spatially uniform transmission. In order for substantial uniform transmission to be achieved, the difference between the percentage of light transmitted through the background as compared to the percentage of light transmitted through the image should vary by no more than 5%, and preferably by no more than 3%, and more preferably by less than 1% over the portion of the optical spectrum of interest. For filter arrangements designed to be used in the visible range, the relevant portion of the optical spectrum is 480 nm to 630 nm, and more preferably 400 nm to 700 nm. If the difference in transmission is less than 5% across this range, then the image will tend to be substantially imperceptible when viewed in transmission. The smaller the difference in percent transmission across the visible spectrum, however, the less perceptible the image will become. Further, as the center of the photopic response is at 550 nm, the percentage of light transmitted through the image and background should be minimized to the extent possible around this wavelength to maximize the imperceptibility of the image in transmission.

Referring to FIG. 1, transmission balance is achieved by absorption in the first and second metal layers 15, 19 and by sandwiching the first dielectric layer 17 between the first and second metal layers. The thickness of a metal thin film determines how much light it will absorb, reflect, and transmit. Therefore, the second metal layer 19 begins the transmission balancing process by partially absorbing light entering it from the image and background. Sandwiching the dielectric layer 17 between the two metal layers 15, 19 creates, in essence, a reflection cavity that causes the light transmitted through upper metal layer 19 to be partially reflected multiple times between the two metal layers. The multiple reflections between the metal layers through the first dielectric layer results in the absorption of the light at every reflection, thus reducing and equalizing the energy level of the light exiting through the substrate.

By tuning the cavity to absorb certain wavelengths more than others, transmission balance can be further improved. The reflection cavity created by layers 15, 17, and 19 is tuned by setting the optical thickness of the dielectric layer 17 so that the electric field maximum of the light waves desired to be removed most through transmission occur within one of the metal layers 15, 19, thereby inducing maximum absorption in the metal layers. Further, by setting the optical thickness of the first dielectric layer to an odd multiple of one-quarter wavelength for the particular wavelength desired to be removed, the transmitted spectrum will undergo destructive interference at that wavelength. Therefore, by varying the thickness of the first dielectric layer 17, certain portions of the transmitted spectrum can be de-emphasized relative to the rest of the transmitted spectrum. Further, by using the three layers to reduce transmission differences, it becomes possible to better eliminate the differences while at the same time maintaining a relatively high overall transmission rate if desired.

The filter arrangements according to the present invention may have a variety of overall transmission rates ranging from approximately 5% to 60%. The exact transmission of the filter arrangement will depend on the particular design requirements such as the brightness of the reflected colors desired and the particular application of the filter arrangement. For example, if the filter arrangement is to be used for sunglasses then a total transmission rate of approximately 8% to 20% is desirable. On the other hand, the filter arrangement preferably has a total transmission rate of between 20% to 33% if it is to be used outdoors, (e.g. exterior windows of a building) and a transmission rate of greater than approximately 40% if the intended use is indoors (e.g. sky box windows for indoor arenas and hockey rink barrier windows).

Depending on the anticipated back lighting conditions in the environment that the filter arrangement will be used, it may also be desirable to reduce reverse reflectance of the filter arrangement to ensure that excessive glare is not produced by the filter arrangement. In such circumstances, it may also be desirable to equalize the reverse reflectance between the image and background portions of the filter arrangement to ensure that the pattern remains substantially imperceptible even when observed in reflection from the backside.

The filter arrangements of the present invention may be used in three different lighting circumstances: (a) the intensity of light incident on the reflecting side is substantially greater than the intensity of light incident on the reverse side; (b) the intensity of light incident on the reflecting side is approximately the same as the intensity of light incident on the reverse side; and (c) the intensity of light incident on the reflecting side is substantially less than the intensity of light incident on the reverse side. When the filter arrangement is subjected to the circumstances in (b) and (c), glare off the reverse side will be high if the reverse reflectance of the filter arrangement is high. Thus, when such circumstances are anticipated, it is desirable to reduce the amount of reverse reflection as well as balance the reverse reflection between the image and background portions of the filter arrangement. To reduce glare, the intensity of the reverse reflectance should be less than the intensity of the transmission over the portion of the optical spectrum of interest. Therefore, reverse reflectance is preferably less than the percentage of light transmitted through the filter arrangement over the portion of the optical spectrum of interest. More preferably reverse reflectance should be less than 10% over the range of the optical spectrum of interest. As those skilled in the art will appreciate, however, the actual amount of acceptable reverse reflectance will vary depending upon the intensity of light transmitted through the filter arrangement and the circumstances in which the filter arrangement is used.

To ensure that the pattern remains substantially imperceptible from the reverse side even when observed under high back lighting conditions, it is desirable to balance the difference in the reverse reflectance between the image and the background. The difference in reverse reflectance between the image and background is preferably no greater than 5%, and more preferably less than 2% over the range of the optical spectrum of interest. For filter arrangements that are to be used in the visible spectrum, it is particularly desirable to achieve such balance around 550 nm. However, as the total amount of reverse reflectance decreases, larger differences in the overall reverse reflectance rate between the background and image are tolerable. Therefore, while it is preferable to have the reverse reflectance between the image and background to be no greater than 5%, greater variances may be tolerable when the overall reverse reflectance is less than 10% or when little or no back lighting exists in the environment in which the filter arrangement will be used.

In the filter arrangement shown in FIG. 1, reverse reflectance is lowered and balanced by the first dielectric layer 17 sandwiched between the first and second metallic layers 15, 19. This structure functions in the same manner as it does for balancing transmitted light. Light transmitted through the bottom metal layer 15 enters the dielectric layer 17 and is reflected multiple times between the metal layers 15 and 17, with each reflection resulting in a portion of the light being absorbed, thus reducing the amount of light reflected in reverse reflection. Additionally, the thickness of the dielectric, for the same reasons previously discussed, will create destructive interference patterns within a portion of the visible spectrum. The interference patterns will further reduce the amount of light reflected on the reverse side. However, because light from the reverse side enters the first dielectric layer 17 only after passing through the metal layer 15, a phase shift will occur in the light reflected from the interface between metal layer 15 and substrate 13. This phase shift along with the phase shift at the interface between the dielectric layer 17 and metal layer 19 should be taken into account when determining the desired thickness of the first dielectric layer 17.

By setting the thickness of first metal layer 15 less than second metal layer 19, the overall amount of back reflection experienced will be reduced because the amount of light initially reflected from the interface between metal layer 15 and substrate 13 will be reduced. Conversely, making the first metal layer 15 thicker than the second metal layer 19 will tend to increase overall back reflection. However, it will have the concomitant effect of attenuating differences in reverse reflection caused by the upper layers, thereby balancing the reverse reflection curves for the image and background portions of stack 11.

FIG. 2 is a chart that summarizes how some of the desired characteristics of an optical filter arrangement having the configuration shown in FIG. 1 are related to design aspects of the filter arrangement. For example, if an overall transmission rate of greater than 30% is desired, then the sum of the thickness of metal layers within the optical filter should be no greater than 5.0 nm (assuming the metal used has an extinction coefficient of approximately 4). When the difference in transmission between the image and background areas needs to be lowered, either a tinted substrate may be used or the first metal layer 15 may be made thicker than the second metal layer 19. When low rear reflection is desired, the second metal layer 19 should be thicker than the first metal layer 15. Finally, if brighter colors are desired in the first and second reflected spectrum, the second metal layer 19 should made thicker than the first metal layer 15.

The entrance medium for the filter arrangement shown in FIG. 1, as well as a number of the other embodiments described in the present application, is illustrated as air. It will be appreciated by those skilled in the art, however, that other entrance mediums may also be employed. For example, the filter arrangements may be coated with a protective coating, or laminated with a scratch resistant polymer film. Adding such coatings or polymer films may alter the optical properties of the filter arrangement. Thus, when designing the thicknesses of the various layers of stack 11 to achieve particular reflectance, transmission, and reverse reflectance objectives, the effects of both the entrance and exit medium on the performance of the filter arrangement should be taken into consideration. In other words, the final performance of the design of any optical filter arrangement according to the present invention must take into account the optical characteristics of both the entrance and exit mediums that are intended to be employed in conjunction with the filter arrangement.

Referring now to Table 1, the layer thicknesses of an example of a filter arrangement according to the construction shown in FIG. 1 are shown.

TABLE 1

| Layer No. | Material | Thickness (nm) |
|---|---|---|
| 0 | Glass Substrate | |
| 1 | Cr | 2 |
| 2 | ITO | 100 |
| 3 | Cr | 3 |
| 4 | ITO | 121 |
| | Air | |

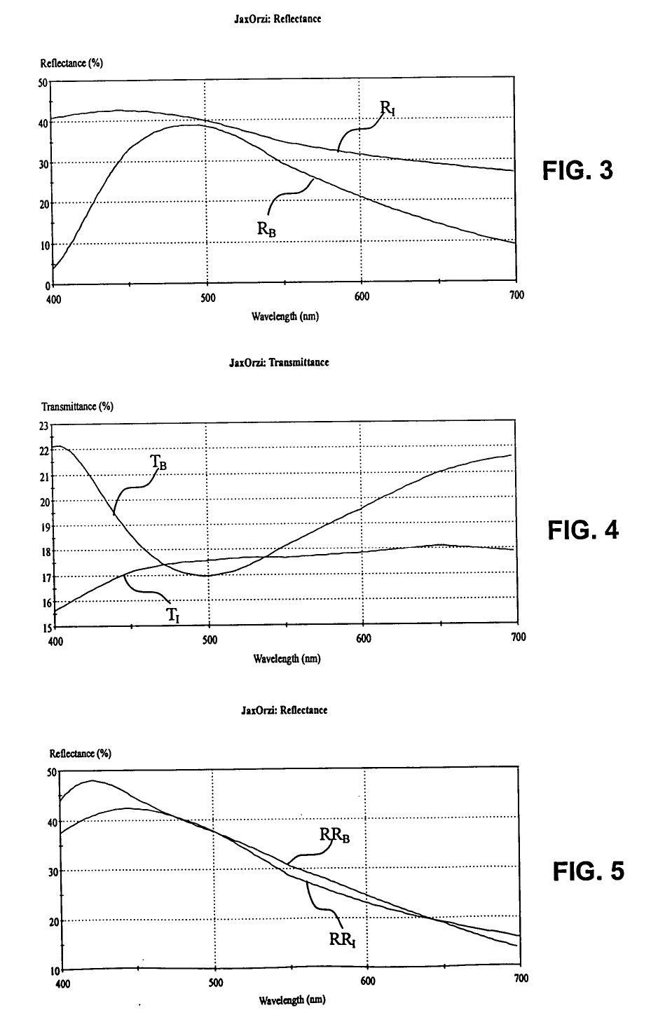

The computed reflection, transmission, and reverse reflection curves in the range of 400 to 700 nm for the filter arrangement of Table 1 are illustrated in FIGS. 3, 4, and 5, respectively. As seen from the reflection curves for the image (R_{I}) and background (R_{B}) given in FIG. 3, the difference between the percentage of light reflected by the image and background is greater than 5% over a substantial portion of the range of 480 to 630 nm, and particularly over the range of 400 to 700 nm. As a result, the reflected image will be perceptible by the human eye. However, because the contrast tends to be greatest at the edges of the photopic region rather than in the center, contrast between the background and image will generally be perceived as being low when observed by the human eye. Indeed, the computed contrast between the image and background at 550 nm is only about 0.07. Thus, the reflected pattern for a filter arrangement constructed in accordance with Table 1 will generally exhibit low contrast in the center of the photopic range.

In terms of the reflected color, it will be observed that the second dielectric layer (fourth layer) has an optical thickness of ½λ for approximately 490 mn light, ¾λ for approximately 330 nm light. As a result, constructive interference can be observed in the background reflectance curve at approximately 490 nm, while destructive interference is observed as the wavelengths enter the blue region of the spectrum. Similarly, because the first dielectric layer (second layer) has an optical thickness of ½λ at approximately 400 nm and approximately ¼λ at approximately 800 nm, a slight constructive interference is observed in the image reflection curve around 400 nm and a slight destructive interference is observed in the curve as it approaches 700 nm.

Reviewing the computed transmittance curves for the image (T_{I}) and background (T_{B}) shown in FIG. 4 it is observed that the overall percentage transmittance of the filter construction generally ranges between about 15% and 22%. Accordingly, the filter arrangement of Table 1 would be suitable for sunglasses. It is also observed from reviewing the transmission curves that the difference in the percentage of light transmitted through the background and the percentage of light transmitted through the image varies by less than 3% over the region of 480 nm to 630 nm and less than 5% over the region of 400 nm to 700 nm. Thus, the pattern produced by the filter arrangement of FIG. 1 will be substantially imperceptible when viewed in transmission through the filter arrangement. Further, because the greatest differences in the percentage of light transmitted through the image and background actually occur at the edges of the waveband of interest, and at the center of the photopic response curve the transmission is nearly the same, any observed contrast between the transmitted image and background will be very slight.

From the computed reverse reflectance curves shown in FIG. 5, it can be seen that the percentage of light reflected from the image (RR_{I}) and background (RR_{B}) regions of the filter arrangement from the back side or substrate side of the filter arrangement is substantially the same over the entire range of 480 nm to 500 nm. Accordingly, no pattern will be observable in reverse reflection for a filter arrangement having the construction given in Table 1. It will be noted, however, that the reverse reflection tends to be high, ranging from approximately 40% at 400 nm to 15% at 700 nm, and being about 30% at 550 nm. Thus, the filter arrangement given by Table 1 would tend to be best suited for applications having low back lighting conditions in order to avoid unacceptable glare.

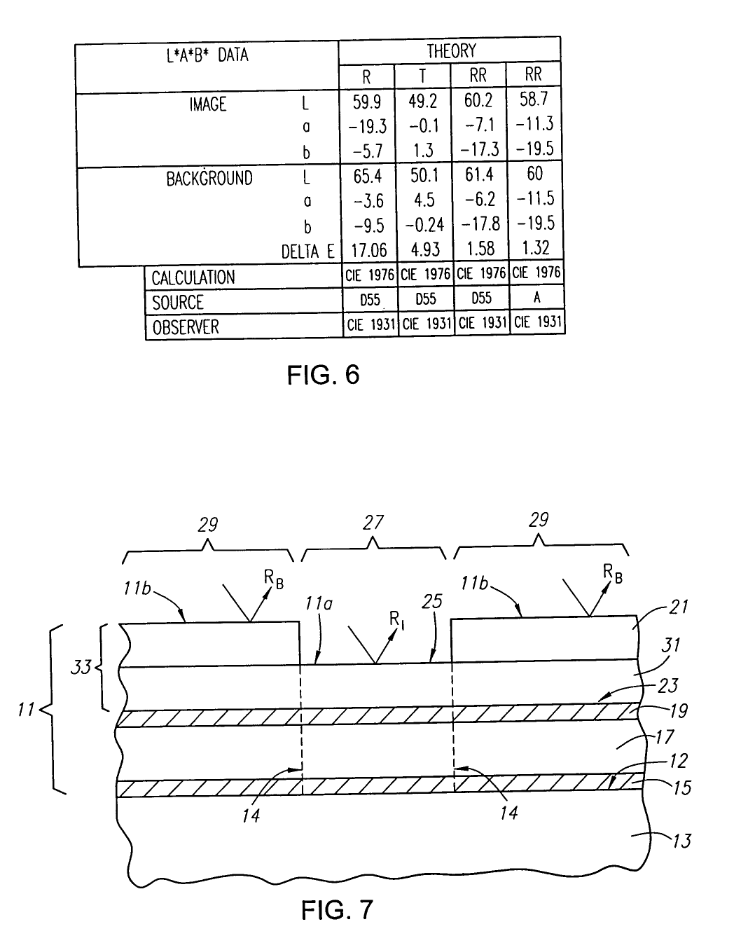

An alternative method may be used for determining the differences in light reflected by and transmitted through the image and background portions of stack 11, as opposed to simply measuring the difference in percentages reflected or transmitted in relative intensities as described above. Alternatively, the two methods described herein for gauging the pattern reflectance, transmission, and reverse reflectance may be used in combination. The method comprises computing theoretically the perceived color of the different spectrums and comparing values of the perceived color as obtained from chromatic charts that are well known in the art. For example, FIG. 6 represents perceived color calculations as obtained from the filter arrangement of Table 1. Three variables, L, a, and b, are calculated in order to determine where the light reflected from the image and background fits into the chromatic chart, where a and b refer to the a specific color on the chromatic chart and L refers to the photopic brightness of that color. For the image and background reflections on the reflecting side, Lᵢ, aᵢ, and bᵢ, and L_{b}, a_{b}, and b_{b}, respectively, are calculated and the relative difference in the color is calculated as ΔE, where ΔE is given by the following:

ΔE=\sqrt{(aᵢ−a_{b})²+(bᵢ−b_{b})²+(Lᵢ−L_{b})²}.

By computing the ΔE values between the image and background areas for the pattern reflectance, transmission, and reverse reflectance, the entire spectrum that is reflected or transmitted may be summed up and weighted using a single value that is relatively well understood in the art. For example a high ΔE value is desired when comparing the pattern reflection from the image and background. Preferably ΔE is greater than or equal to 17, more preferably ΔE is greater than or equal to 30, and most preferably ΔE is greater than or equal to 40 when comparing the pattern reflection from the background and image. Conversely, a low ΔE value, preferably less than ten, and more preferably less than three, is desired when comparing the transmission and reverse reflectance from the image and background areas.

From reviewing FIG. 6, it can be seen that the theoretical ΔE values for pattern reflection, transmission, and reverse reflection for the filter arrangement design given in Table 1 are 17.06, 4.93 and 1.58, respectively, thus falling within the scope of the invention. The low theoretical ΔE value of 17.06 for pattern reflectance confirms that the contrast between the image and background for the filter arrangement of Table 1 is on the lower limit of acceptable contrast to ensure visibility of the pattern in reflection. The theoretical ΔE value for transmission indicates that the filter arrangement has moderate to good balance between the background and pattern. The theoretical ΔE value for the reverse reflection indicates that the filter design of Table 1 has very good balance between the pattern and image in reverse reflection, and thus the pattern will be substantially imperceptible in reverse reflection.

Additional layers may be added as needed to the filter arrangement of FIG. 1 to additionally compensate for various colors in the image and background, create additional colors in the image or background, improve the intensity of the reflected pattern, compensate for the need for more or less reverse reflectance, and compensate for circumstances in which the filter arrangement may be used. For example, FIG. 7 illustrates an alternative embodiment of the filter arrangement construction shown in FIG. 1 having 5 layers. The filter arrangement shown in FIG. 7 includes an additional dielectric layer 31 (fourth layer) disposed between the second metal layer 19 (third layer) and the dielectric layer 23 (fifth layer). As a result, stack 11a, which defines the image of the pattern, includes metal layer 15, dielectric layer 17, metal layer 19, and dielectric layer 31. Stack 11b, which defines the background of the pattern, also includes metal layer 15, dielectric layer 17, metal layer 19, and dielectric layer 31, but also includes dielectric layer 21 deposited thereon. As those skilled in the art will appreciate, however, if dielectric layers 31 and 21 are made of the same dielectric material, then these layers may be properly treated as a combined layer 33 relative to stack 11b and their combined thickness will determine the composition of the second spectrum reflected from stack 11b.

Dielectric layer 31 may be of a very thin nature and simply added to provide protection to metal layer 19 from oxidation and other environmental effects. This is desirable in many applications because the exposed portions of the second metal layer 19, depending on the metal used, are often easily damaged or readily oxidize over time, thereby altering the optical properties of the filter arrangement. Alternatively, dielectric layer 31 may be of sufficient optical thickness to cause interference in the light reflected from the first reflecting area 27 and thereby alter the color of the first reflected spectrum. In any event, dielectric layer 19 will have the effect of reducing the overall amount of light reflected from the upper surface of the second metal layer within stack 11a.

Referring now to Table 2, the layer thicknesses of an example of a filter arrangement according to the construction shown in FIG. 7 are shown.

TABLE 2

| Layer No. | Material | Thickness (nm) |
|---|---|---|
| 0 | Glass Substrate | |
| 1 | Cr | 2 |
| 2 | ITO | 60 |
| 3 | Cr | 2.5 |
| 4 | ITO | 24 |
| 5 | ITO | 180 |
| | Air | |

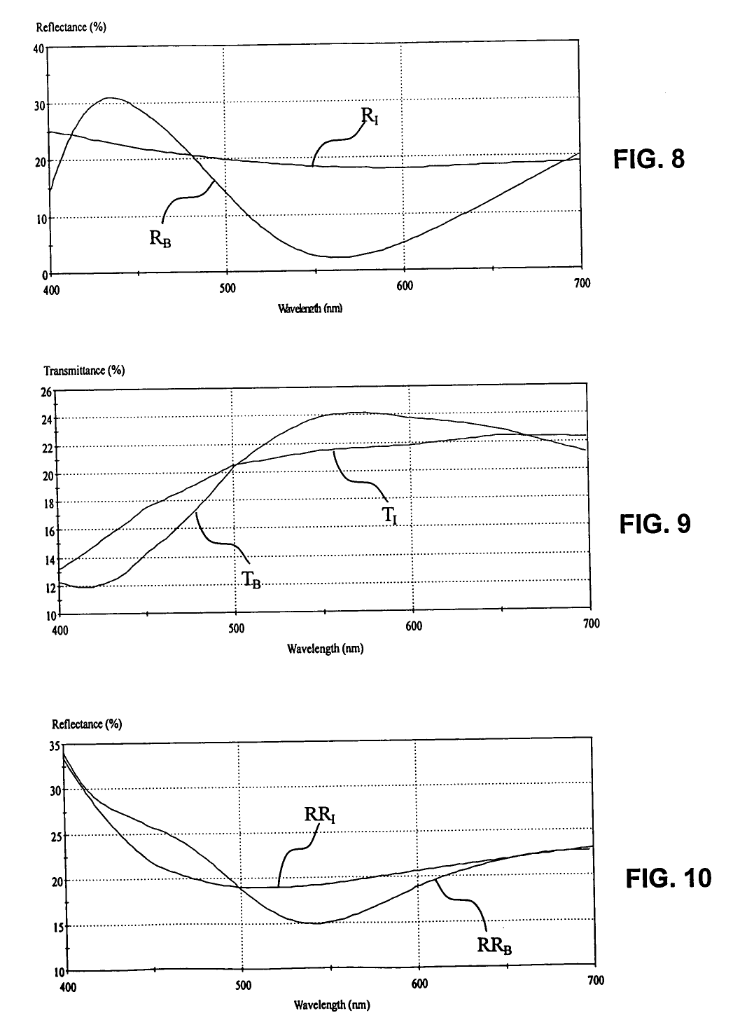

The computed reflection, transmission, and reverse reflection curves in the range of 400 to 700 for the filter arrangement of Table 2 are illustrated in FIGS. 8, 9, and 10, respectively. Further, the theoretical ΔE values between the image and background area pattern reflectance, transmission and reverse reflectance for the filter arrangement given in Table 2 are shown in FIG. 11.

As seen from the reflection curves for the image (R_{I}) and background (R_{B}) given in FIG. 8, the difference between the percentage of light reflected by the image and background is more than 10% over a substantial portion of the range of 480 to 630 nm, and the difference is greater than 5% over most of the vast majority of the range of 400 nm to 700 nm. The contrast at 500 nm is also 0.75. Further, the theoretical ΔE calculation for the pattern reflectance yields a value of 54.06 as shown in FIG. 11. Thus, the filter arrangement given in Table 2 will exhibit very high contrast between the pattern and image over a large portion of the visible spectrum, and will therefore result in a pattern having high visibility.

In terms of the reflected color, it will be observed that the combined thickness of dielectric layers 31 and 21 (fourth and fifth layers) have an optical thickness of λ at approximately 430 nm light and ¾λ for approximately 570 nm light. As a result, constructive interference can be observed in the background reflectance curve at approximately 430 nm, while destructive interference is observed at approximately 570 nm. On the other hand, dielectric layer 31 (fourth layer) does not produce any significant interference in the reflected image spectrum.

Reviewing the computed transmittance curves for the image (T_{I}) and background (T_{B}) shown in FIG. 9 it is observed that the overall percentage transmittance of the filter construction generally ranges between about 12% and 22%. Accordingly, the filter arrangement of Table 2 would be suitable for sunglasses. It is also observed from reviewing the transmission curves that the difference in the percentage of light transmitted through the background and the percentage of light transmitted through the image varies by less than 3% over the region of 480 nm to 630 nm and less than 5% over the region of 400 nm to 700 nm. Thus, the pattern produced by the filter arrangement of FIG. 7 will be substantially imperceptible when viewed in transmission through the filter arrangement. This is generally confirmed by the fact that there is only a 2% difference in transmission at 550 nm between the image and background. Further, the theoretical ΔE calculation for the pattern transmission yields a value less than 10.

From the computed reverse reflectance curves shown in FIG. 10, it can be seen that the difference between the percentage of light reflected from the image (RR_{I}) and percentage of light reflected from the background (RR_{B}) regions of the filter arrangement from the substrate side of the filter arrangement is less than 5% over the range of 400 to 700 nm. Thus, the filter arrangement has acceptable reverse reflection. However, as the difference in reverse reflection tends to be high at 550 nm, and is approximately 5% over a substantial portion of the visible spectrum, a pattern will be observable in reverse reflection for a filter arrangement having the construction given in Table 2 when significant back lighting exists. This is generally confirmed by the theoretical ΔE value calculated for the pattern reverse reflectance, which is 12.7. Futhermore, because the overall reverse reflection for the filter arrangement tends to be high, ranging from approximately 35% at 400 nm to 15% at 550 nm, filter arrangements having the construction given by Table 2 would be best suited for applications having low back lighting conditions in order to avoid unacceptable glare, as well as to ensure that the pattern does not become visible as a result of reverse reflection.

The layer thicknesses for a second example of a filter arrangement according to the construction shown in FIG. 7 are given in Table 3 below.

TABLE 3

| Layer No. | Material | Thickness (nm) |
|---|---|---|
| 0 | Glass Substrate | |
| 1 | Cr | 1.5 |
| 2 | ITO | 50 |
| 3 | Cr | 2 |
| 4 | ITO | 30 |
| 5 | ITO | 150 |
| | Air | |

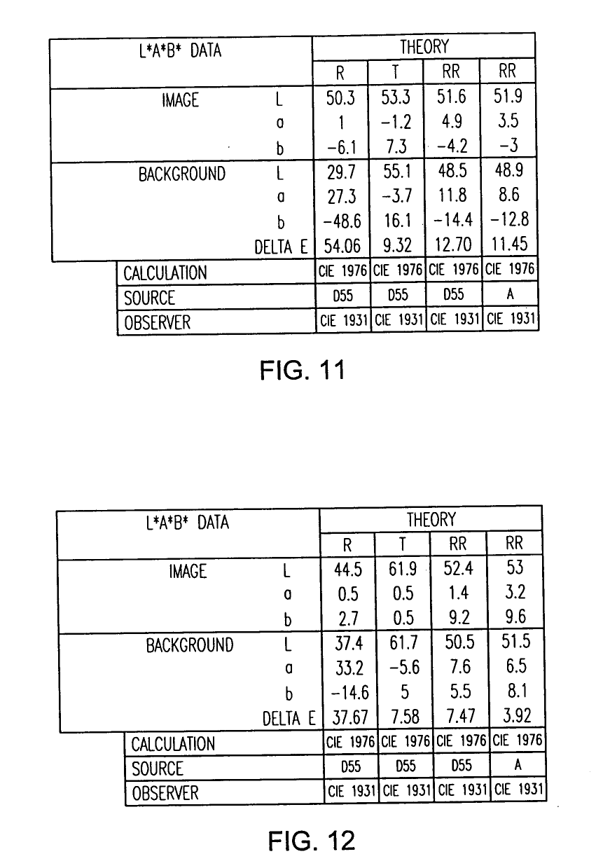

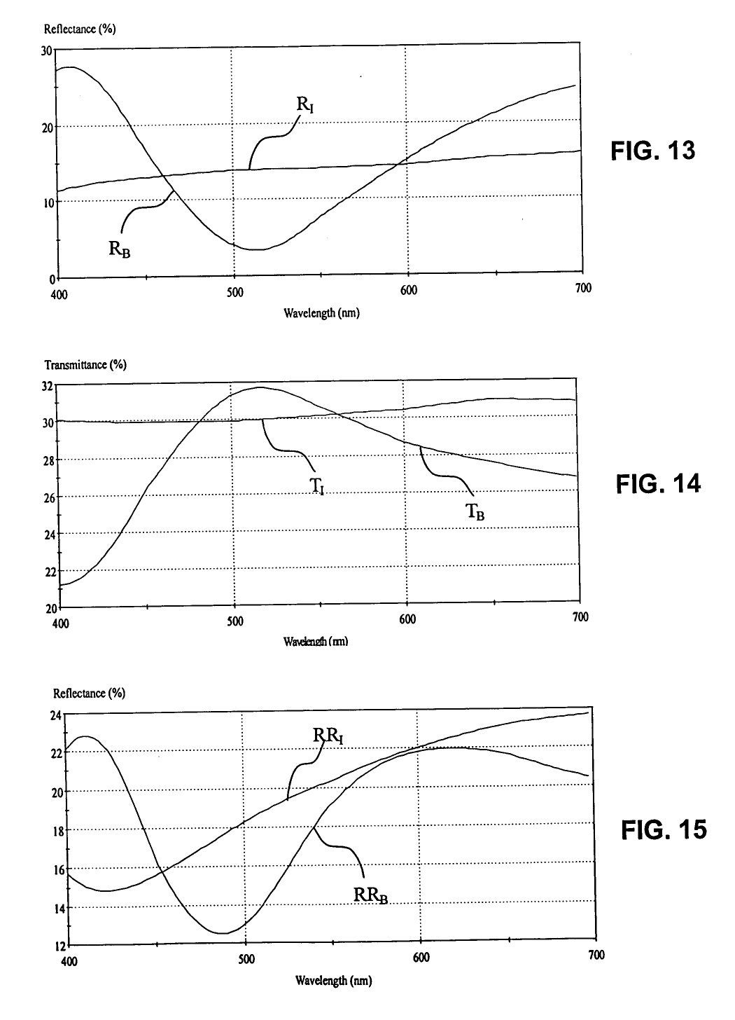

The computed reflection, transmission, and reverse reflection curves in the range of 400 to 700 nm for the filter arrangement of Table 3 are illustrated in FIGS. 13, 14, and 15, respectively, and the theoretical ΔE values between the image and background area pattern reflectance, transmission and reverse reflectance are shown in FIG. 12.

As seen from the reflection curves for the image (R_{I}) and background (R_{B}) given in FIG. 13, the difference between the percentage of light reflected by the image and background is more than 5% over a substantial portion of the range of 480 to 630 nm, and the difference is greater than 10% over some portions. The contrast at 550 nm is 0.33. Further, the theoretical ΔE calculation for the pattern reflectance yields a value of 37.67 as shown in FIG. 12. Thus, the filter arrangement given in Table 3 will exhibit good contrast between the pattern and image over a large portion of the visible spectrum, and will thus result in a pattern having fairly high visibility.

In terms of the reflected color, it will be observed that the combined thickness of dielectric layers 31 and 21 (fourth and fifth layers) have an optical thickness of λ at approximately 380 nm light, ¾λ for approximately 510 nm light, and ½λ for approximately 760 nm light. As a result, constructive interference can be observed in the background reflectance curve at approximately 400 nm and 700 nm, while destructive interference is observed at approximately 510 nm. On the other hand, dielectric layer 31 (fourth layer) does not produce any significant interference in the reflected image spectrum.

Reviewing the computed transmittance curves for the image (T_{I}) and background (T_{B}) shown in FIG. 14 it is observed that the overall percentage transmittance of the filter construction generally ranges between about 22 and 30%. Accordingly, the filter arrangement of Table 3 would be suitable for outdoor uses such as exterior windows of a building and window film to be applied to such windows. It is also observed from reviewing the transmission curves that the difference in the percentage of light transmitted through the background and the percentage of light transmitted through the image varies by less than 4% over the region of 480 nm to 630 nm. Thus, the pattern produced by the filter arrangement of Table 3 will be substantially imperceptible when viewed in transmission through the filter arrangement. This is generally confirmed by the fact that there is only a slight difference in transmission at 550 nm between the image and background. Further, the theoretical ΔE calculation for the pattern transmission yields a value of 7.58.

From the computed reverse reflectance curves shown in FIG. 15, it can be seen that the difference between the percentage of light reflected from the image (RR₁) and percentage of light reflected from the background (RR_{B}) regions of the filter arrangement from the substrate side of the filter arrangement is less than about 5% over the range of 480 to 630 nm. Accordingly, the pattern of the filter arrangement given in Table 3 will be substantially visually imperceptible even when observed in reverse reflection. This is generally confirmed by the theoretical ΔE value calculated for the pattern reverse reflectance, which is 3.92. Because the overall reverse reflection for the filter arrangement is generally greater than 10% and less than about 20% in the range of 400 nm to 700 nm, filter arrangements having the construction given by Table 3 are better suited for low to moderate back lit environments.

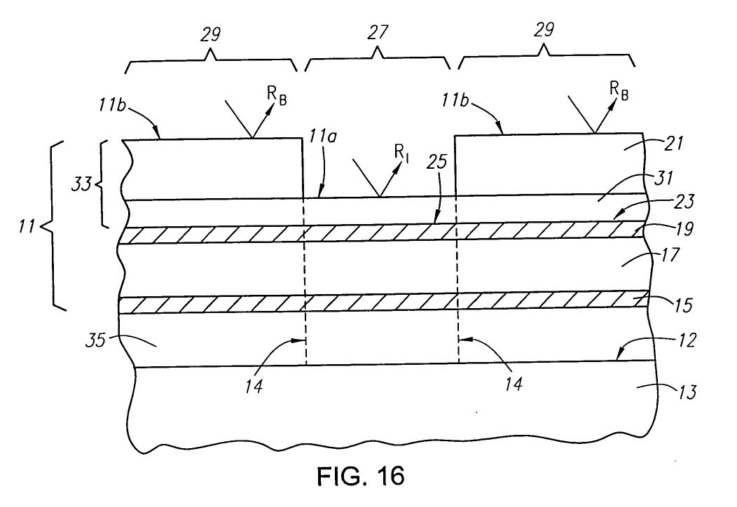

FIG. 16 illustrates a further modification of the filter arrangement construction shown in FIG. 1 having six layers. The filter arrangement shown in FIG. 16 is the same as that described in connection with FIG. 7, except that it includes a dielectric layer 35 interposed between the substrate 13 and first metal layer 15 . As a result, stack 11a, which defines the image of the pattern includes dielectric layer 35, metal layer 15, dielectric layer 17, metal layer 19, and dielectric layer 31. Stack 11b, which defines the background of the pattern, includes the same layers as stack 11a, but also includes dielectric layer 21 deposited thereon. As those skilled in the art will appreciate, if dielectric layers 31 and 21 are made of the same dielectric material, then these layers may be properly treated as a combined layer 33 relative to stack 11b.

As in the embodiment illustrated in FIG. 7, dielectric layer 31 may be of a very thin nature and simply added to provide protection to metal layer 19 from oxidation and other environmental effects, or it may be of sufficient optical thickness to cause interference in the light reflected from the first reflecting area 27.

Dielectric layer 35 is an optical impedance matching layer; added to achieve reduced reverse reflection. The optical thickness of dielectric layer 35 will typically range between about one-eighth of a wavelength for a wavelength at the upper limit of the spectral band for which the filter arrangement is designed to one-half a wavelength for a wavelength at the lower limit of the spectral band for which the optical filter arrangement is designed. Dielectric layer 35 may advantageously be set at an odd multiple of a quarter-wavelength to create interference patterns in a desired portion of the reverse reflected spectrum, thus helping to reduce imbalance between the image and background in the reverse reflection.

The layer thicknesses of an example of a filter arrangement according to the construction shown in FIG. 16 are listed below in Table 4. The six layers making up the stack are conveniently designated the first through sixth, beginning with dielectric layer 35 disposed on the substrate.

TABLE 4

| Layer No. | Material | Thickness (nm) |
|---|---|---|
| 0 | Glass Substrate | |
| 1 | ITO | 50 |
| 2 | Cr | 2 |
| 3 | ITO | 58 |
| 4 | Cr | 2 |
| 5 | ITO | 5 |
| 6 | ITO | 170 |
| | Air | |

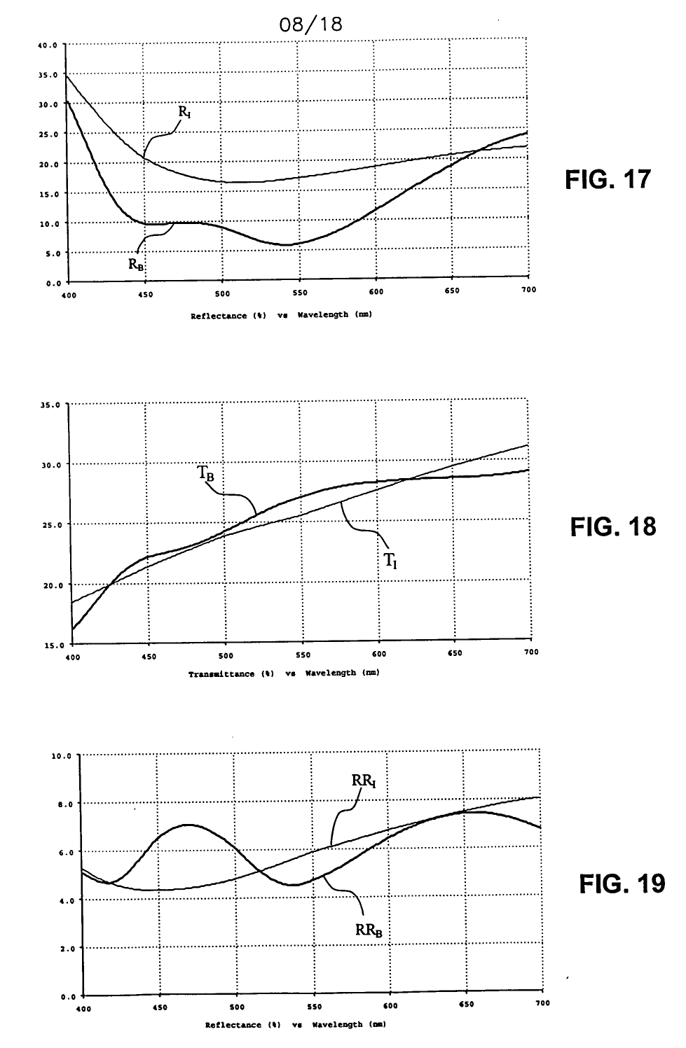

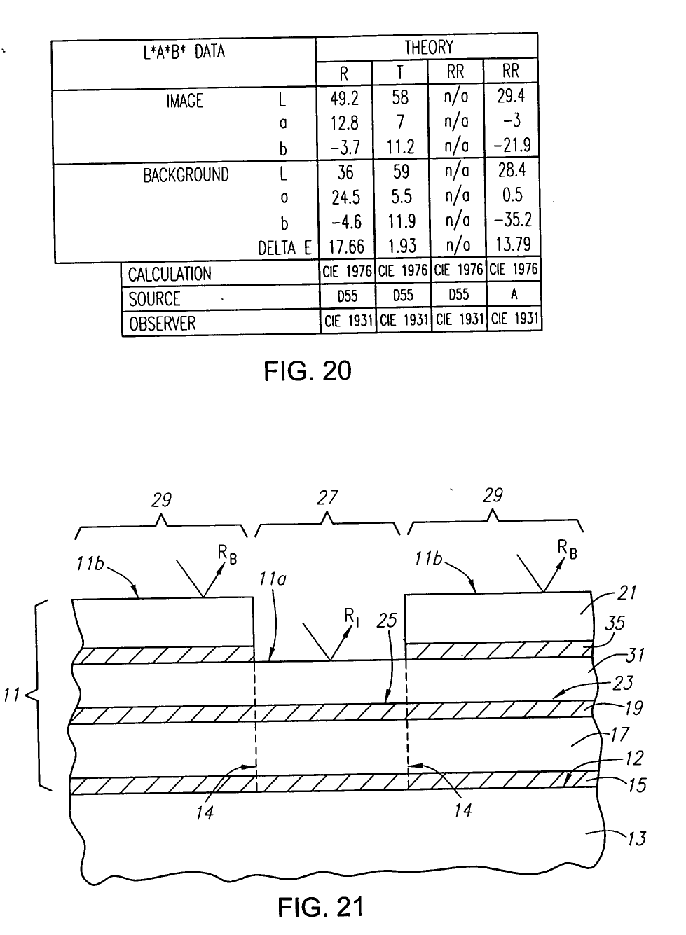

The computed reflection, transmission, and reverse reflection curves in the range of 400 to 700 nm for the filter arrangement of Table 4 are illustrated in FIGS. 17, 18, and 19, respectively, and the theoretical ΔE values between the image and background area pattern reflectance, transmission and reverse reflectance are shown in FIG. 20.

As seen from the reflection curves for the image (R_{I}) and background (R_{B}) given in FIG. 17, the difference between the percentage of light reflected by the image and background is more than 10% over a substantial portion of the range of 480 to 630 nm, and is more than 5% over almost the entire range of 400 nm to 700 nm. The contrast at 550 nm is 0.44. However, the theoretical ΔE calculation for the pattern reflectance yields a value of 17.66 as shown in FIG. 20. Thus, the filter arrangement given in Table 4 will exhibit fair to good contrast between the pattern and image over a large portion of the visible spectrum, and will thus result in a pattern having moderate overall visibility.

In terms of the reflected color, it will be observed that the combined thickness of dielectric layers 31 and 21 (fourth and fifth layers) have an optical thickness of λ at approximately 380 nm light, ¾λ for approximately 510 nm light, and ½λ for approximately 760 nm light. As a result, constructive interference can be observed in the background reflectance (R_{B}) curve at approximately 400 nm and 700 nm, while destructive interference is observed at approximately 510 nm. It can also be seen from reviewing the reverse reflectance curve that a slight amount of constructive interference exists at approximately 460 to 480 nm. This constructive interference is created by reflections from the interfaces between dielectric layers 35 and 17 and their respective surrounding layers. In contrast, there is a small amount of destructive interference in the image reflectance curve (R_{I}) between approximately 460 nm and 500 nm, which is similarly created by light reflecting from the interfaces of dielectric layers 35 and 17 and their respective surrounding layers.

Reviewing the computed transmittance curves for the image (T_{I}) and background (T_{B}) shown in FIG. 18 it is observed that the overall percentage transmittance of the filter construction generally ranges between about 15% and 30% over the range of 400 nm to 700 nm. However, between the range of 480 nm to 630 nm, the overall percentage of transmitted light ranges between 20% and 30%. Accordingly, the filter arrangement of Table 4 would be suitable for outdoor uses such as exterior windows of a building and window film to be applied to such windows. It is also observed from reviewing the transmission curves that the difference in the percentage of light transmitted through the background and the percentage of light transmitted through the image varies by less than about 2% over the region of 400 nm to 700 nm. Thus, the pattern produced by the filter arrangement of Table 4 will be substantially imperceptible when viewed in transmission through the filter arrangement. This is generally confirmed by the fact that there is only a slight difference in transmission at 550 nm between the image and background. Further, the theoretical ΔE calculation for the pattern transmission yields a value of 1.93, confirming that a filter arrangement constructed in accordance with Table 4 will have very good transmission balance between the background and image areas.

From the computed reverse reflectance curves shown in FIG. 19, it can be seen that the difference between the percentage of light reflected from the image (RR_{I}) and percentage of light reflected from the background (RR_{B}) regions of the filter arrangement from the substrate side of the filter arrangement is less than about 3% over the range of 480 to 630 nm. And, although the theoretical ΔE value calculated for the pattern reverse reflectance is fairly high at 13.79, because the overall reflectance is actually quite low, averaging approximately 6% across the visible spectrum, the filter arrangement given by Table 4 will exhibit exceptional reverse reflection characteristics. Accordingly, the pattern of the filter arrangement given in Table 4 will be substantially visually imperceptible even when observed in reverse reflection in a highly back lit environment.

Therefore, given the overall characteristics of the filter arrangement design of Table 4, it is preferably suitable for applications where high color contrast in the pattern design are not required, but superior reverse reflections are.

Three additional embodiments of filter arrangements according to the present invention are illustrated in FIGS. 21, 22, and 23.

The filter arrangement shown in FIG. 21 is the same as that described in connection with FIG. 7, except that a third metal layer 35 is interposed between the dielectric layer 31 and dielectric layer 21. It will be noted however, that metal layer 35 only extends over the primary area 23 of metal layer 19 . As a result, stack 11a, which defines the image of the pattern, includes metal layer 15, dielectric layer 17, metal layer 19, and dielectric layer 31. Stack 11b, which defines the background of the pattern, includes the same layers as stack 11a, but also includes metal layer 35 and dielectric layer 21 deposited thereon.

As in the embodiment illustrated in FIG. 7, dielectric layer 31 may be of a very thin nature and simply added to provide protection to metal layer 19 from oxidation and other environmental effects, or it may be of sufficient optical thickness to cause interference in the light reflected from the first reflecting area 27. Metal layer 35 helps to balance transmission through the background portion of the filter arrangement so that it better matches that of the image portion. Metal layer 35 accomplishes this by not only absorbing light as it is transmitted through the layer, but in combination with dielectric layer 31 and metal layer 19 an optical reflection cavity may be created. This reflection cavity will work in the same manner as the reflection cavity produced by metal layer 15, dielectric layer 17 and metal layer 19. This approach also allows for a thinner metal layer 15 to be used, while simultaneously improving contrast between the pattern and image. As a result, filter arrangements having the construction illustrated in FIG. 21 will typically exhibit better color contrast between the background and image and lower overall reverse reflection than is exhibited by filter arrangements having the configuration shown in FIG. 7.

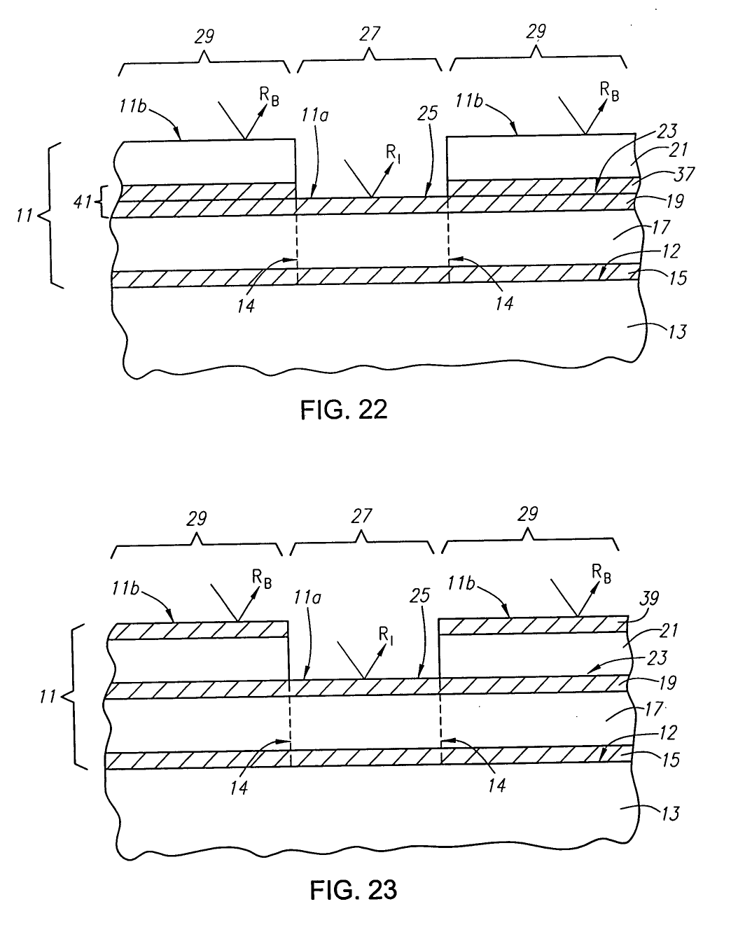

The filter arrangement shown in FIG. 22 is the same as that described in connection with FIG. 1, except that a third metal layer 37 is interposed between the dielectric layer 21 and the metal layer 19. It will be noted however, that metal layer 37 only extends over the primary area 23 of metal layer 19 . As a result, stack 11a, which defines the image of the pattern, includes metal layer 15, dielectric layer 17, and metal layer 19. Stack 11b, which defines the background of the pattern, includes the same layers as stack 11a, but also includes metal layer 37 and dielectric layer 21 deposited thereon. As those skilled in the art will appreciate, if metal layers 19 and 37 are made of the same metal, then these layers may be properly treated as a combined layer 41 relative to stack 11b. The purpose of adding metal layer 37 is to help balance transmission through the background portion of the filter arrangement so that it better matches that of the image portion. Metal layer 37 accomplishes this by increasing the amount of light that is absorbed as it passes through stack 11b. Further, by increasing the thickness of the metal under dielectric layer 21, backgrounds with bright colors can be produced.

The filter arrangement shown in FIG. 23 is the same as that described in connection with FIG. 1, except that a third metal layer 39 is deposited on top of dielectric layer 21. As a result, stack 11a, which defines the image of the pattern, includes metal layer 15, dielectric layer 17, and metal layer 19. Stack 11b, which defines the background of the pattern, includes the same layers as stack 11a, but also includes dielectric layer 21 and metal layer 39 deposited thereon. Metal layer 39 is a very thin layer, typically less than 0.5 nm, and preferably less than or equal to 0.3 nm. The purpose of adding metal layer 39 is to increase the brightness of the background reflection curve. Further, if an entrance medium to the stack is added that has roughly the same index of refraction of the substrate 13, a filter arrangement can be achieved that produces very high color contrast in reflection, but with extremely good balance in transmission and reverse reflection between the image and background. In addition, by changing entrance medium, the overall reverse reflection will be decreased because the difference between the index of refraction of the upper metal layers 39 and 19 and the entrance medium (which is the exit medium in reverse reflection) will be reduced. The effect of changing the entrance medium will be discussed further below in connection with an example of a filter arrangement having the configuration illustrated in FIG. 23.

Referring now to Table 5, the layer thicknesses of an example of a filter arrangement according to the construction shown in FIG. 21 are shown. The six layers making up the stack 11 are conveniently designated the first through sixth, beginning with metal layer 15 disposed on the substrate 13.

TABLE 5

| Layer No. | Material | Thickness (nm) |
|---|---|---|
| 0 | Glass Substrate | |
| 1 | Cr | 0.7 |
| 2 | ITO | 60 |
| 3 | Cr | 2.2 |
| 4 | ITO | 5 |
| 5 | Cr | 1.8 |
| 6 | ITO | 55 |
| | Air | |

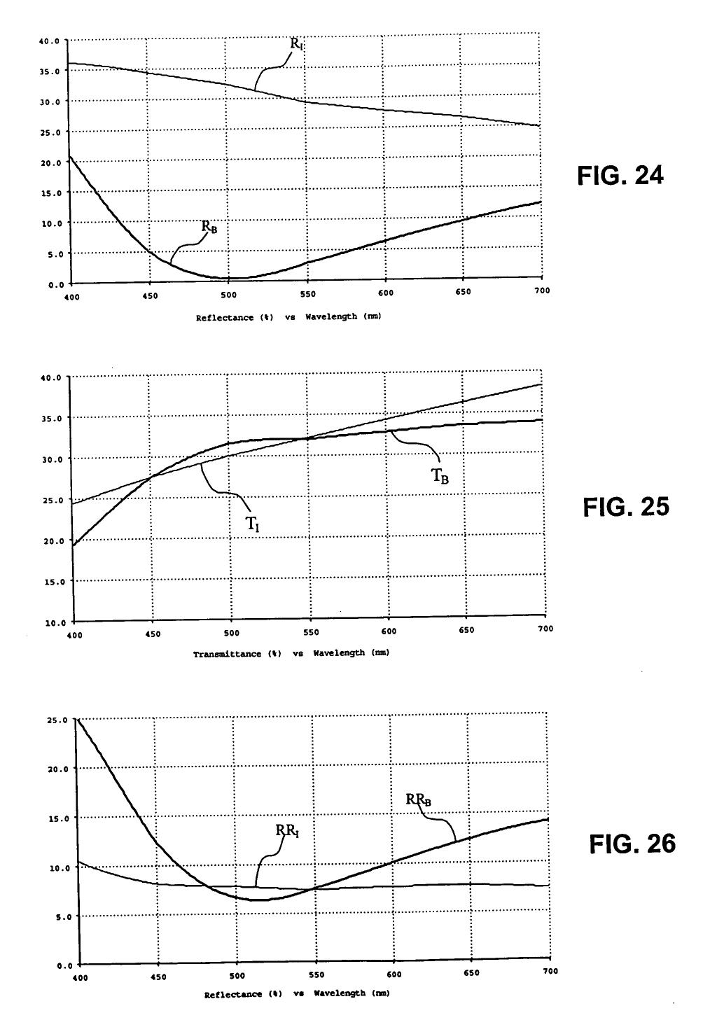

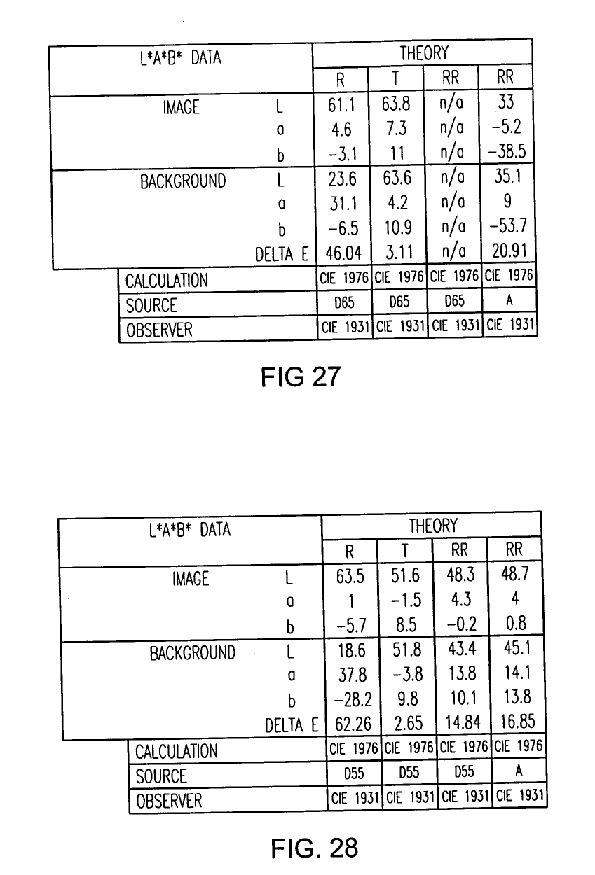

The computed reflection, transmission, and reverse reflection curves in the range of 400 to 700 nm for the filter arrangement of Table 5 are illustrated in FIGS. 24, 25, and 26, respectively, and the theoretical ΔE values between the image and background area pattern reflectance, transmission and reverse reflectance are shown in FIG. 27.

As seen from the reflection curves for the image (R_{I}) and background (R_{B}) given in FIG. 24, the difference between the percentage of light reflected by the image and background is more than 20% over the entire range of 480 to 630 nm. And even at the extreme edges of the photopic range, FIG. 24 indicates that the difference in percentage of light reflected by the background and image is greater than 15%. Further, the contrast at 550 nm is 0.81, and the theoretical ΔE calculation for the pattern reflectance yields a value of 46.04 as shown in FIG. 27. Thus, the filter arrangement given in Table 5 will exhibit extremely high contrast between the pattern and image portion over the entire visible spectrum, and will thus result in a pattern having very high visibility.

It will be noted from Table 5, that dielectric layer 31 (fourth layer) has an extremely small thickness of 5 nm. Thus, dielectric layer 31 does not impact on the reflected image color as illustrated in FIG. 24. The primary purpose of dielectric layer 31 is to protect metal layer 19 (third layer), which would otherwise be exposed in stack 11a, from exposure to environmental effects.

Reviewing the computed transmittance curves for the image (T_{I}) and background (T_{B}) shown in FIG. 25 it is observed that the overall percentage transmittance of the filter construction generally ranges between about 25% and 35% over the visible spectrum. Accordingly, the filter arrangement of Table 5 would be suitable for outdoor uses such as exterior windows of a building and window film to be applied to such windows. It is also observed from reviewing the transmission curves that the difference in the percentage of light transmitted through the background and the percentage of light transmitted through the image varies by less than about 3% over the region of 480 nm to 630 nm, and less than 5% over the range of 400 to 700 nm. Thus, the pattern produced by the filter arrangement of Table 5 will be substantially imperceptible when viewed in transmission through the filter arrangement. This is generally confirmed by the fact that there is no mismatch in transmission at 550 nm between the image and background. Further, the theoretical ΔE calculation for the pattern transmission yields a very low value of 3.11.

From the computed reverse reflectance curves shown in FIG. 26, it can be seen that the difference between the percentage of light reflected from the image (RR_{I}) and percentage of light reflected from the background (RR_{B}) regions of the filter arrangement from the substrate side of the filter arrangement is less than about 5% over the range of 480 to 630 nm. In addition, balance is achieved 550 nm. However, at the extremes of the visible range, the difference in the percentage of reverse reflection between the image and background increases substantially. As a result the theoretical ΔE value of 20.91 calculated for the pattern reverse reflectance is high. But since the filter arrangement generally shows acceptable balance within the range of 480 nm to 630 nm and is perfectly balanced at 550 nm, the pattern will be substantially visually imperceptible in reverse reflection.

The overall reverse reflection for the filter arrangement is generally less than 10% in the range of 480 nm to 630 nm, but increases substantially at the extremes of the visible range, especially in the blue region. Accordingly, given the high overall reverse reflectance and the lack of ideal balance in reverse reflection, the filter arrangement given in Table 5 is better suited for environments having low to moderate back lighting conditions such as sunglasses and visors in which illumination on reverse side is minimal.

The layer thicknesses of an example of a filter arrangement according to the construction shown in FIG. 22 are shown in Table 6 below. The five layers making up the stack I I are conveniently designated the first through fifth, beginning with the first metal layer 15 disposed on the substrate 13.

TABLE 6

| Layer No. | Material | Thickness (nm) |
|---|---|---|
| 0 | Glass Substrate | |
| 1 | Cr | 1.5 |
| 2 | ITO | 50 |
| 3 | Cr | 3 |
| 4 | Cr | 2.15 |
| 5 | ITO | 60 |
| | Air | |

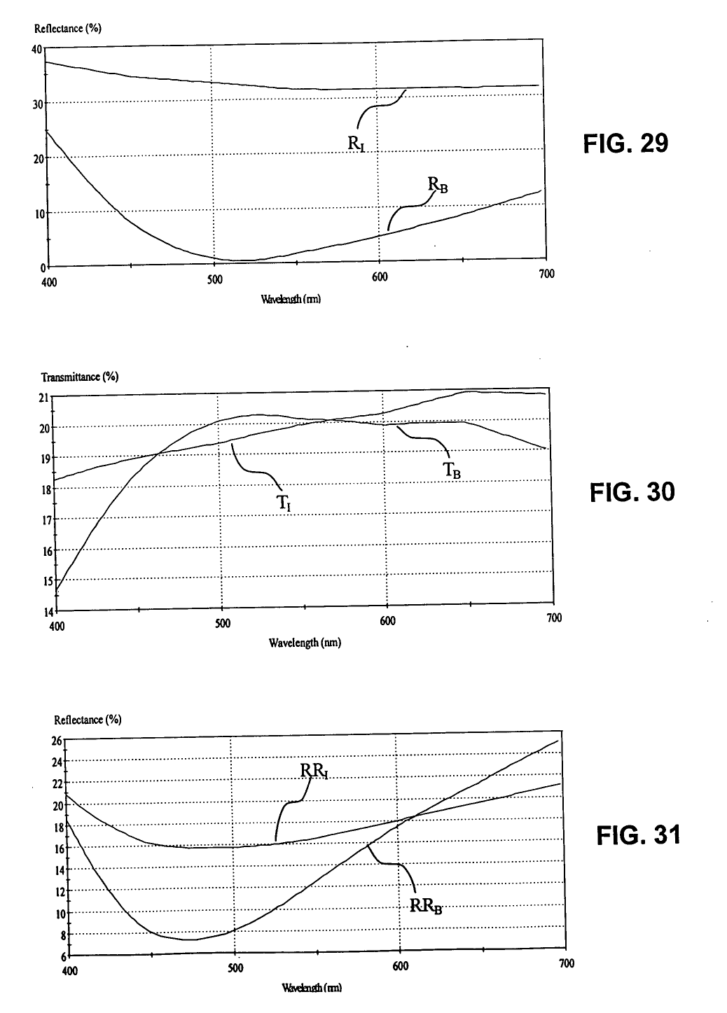

The computed reflection, transmission, and reverse reflection curves in the range of 400 to 700 nm for the filter arrangement of Table 6 are illustrated in FIGS. 29, 30, and 31, respectively, and the theoretical ΔE values between the image and background area pattern reflectance, transmission and reverse reflectance are shown in FIG. 28.

As seen from the reflection curves for the image (R_{I}) and background (R_{B}) given in FIG. 29, the difference between the percentage of light reflected by the image and background is extremely high over the entire visible spectrum. Further, the contrast at 550 nm is 0.91, and the theoretical ΔE calculation for the pattern reflectance yields a value of 62.26 as shown in FIG. 28. Thus, the filter arrangement given in Table 6 will exhibit extremely high contrast between the pattern and image portion over the entire visible spectrum, and will thus result in a pattern having very high visibility.

Reviewing the computed transmittance curves for the image (T_{I}) and background (T_{B}) shown in FIG. 30 it is observed that the overall percentage transmittance of the filter construction is generally less than 20% over the visible spectrum. Accordingly, the filter arrangement of Table 6 would generally be suitable for applications where low transmission is required, such as for sunglasses. It is also observed from reviewing the transmission curves that the difference in the percentage of light transmitted through the background and the percentage of light transmitted through the image varies by less than about 1% over the region of 480 nm to 630 nm, and less than 3% over the range of 400 to 700 nm. Thus, the pattern produced by the filter arrangement of Table 6 will be substantially imperceptible when viewed in transmission through the filter arrangement. This is generally confirmed by the theoretical ΔE calculation for the pattern transmission, which yields a very low value of 2.65.

From the computed reverse reflectance curves shown in FIG. 31, it can be seen that the difference between the percentage of light reflected from the image (RR_{I}) and percentage of light reflected from the background (RR_{B}) regions of the filter arrangement from the substrate side is exceeds a 5% over a significant portion of the range of 480 to 630 nm. In addition, significant imbalance exists at 550 nm. Further, the theoretical ΔE value of 14.84 calculated for the pattern reverse reflectance is high, confirming the general imbalance in the reverse reflection curves. Accordingly, the filter arrangement given in Table 6 is better suited for applications involving low back lighting conditions.

The layer thicknesses of an example of a filter arrangement according to the construction shown in FIG. 23 are shown in Table 7 below. The five layers making up the stack 11 are conveniently designated the first through fifth, beginning with the first metal layer 15 disposed on the substrate 13.

TABLE 7

| Layer No. | Material | Thickness (nm) |
|---|---|---|
| 0 | PET Film | |
| 1 | Cr | 0.77 |
| 2 | ITO | 60 |
| 3 | Cr | 2.5 |
| 4 | ITO | 60 |
| 5 | ITO | 0.3 |
| | Air | |

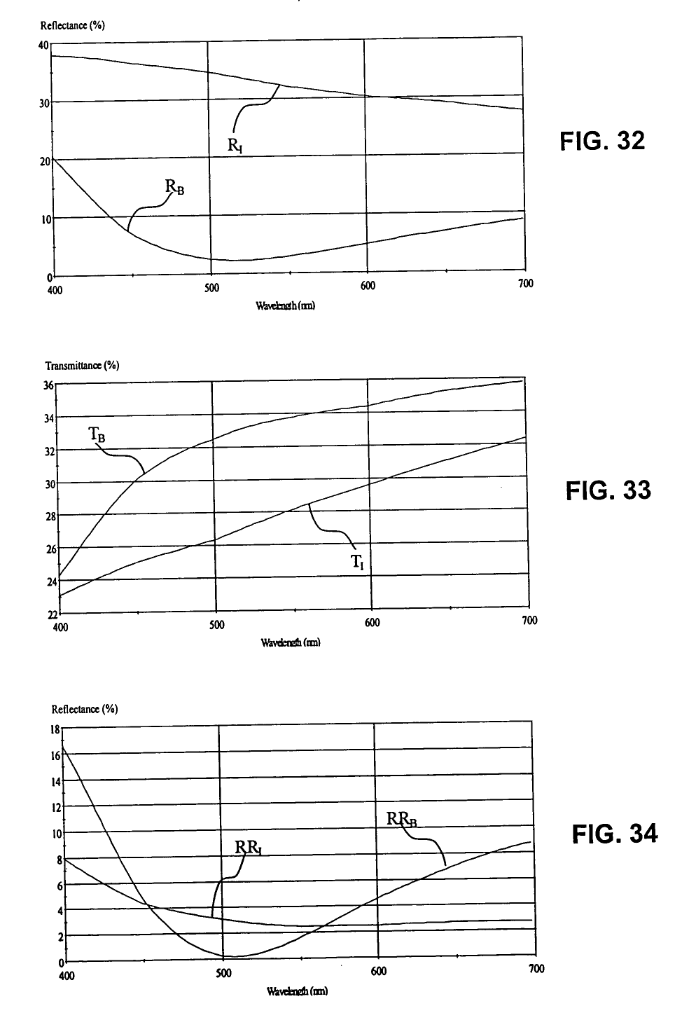

The computed reflection, transmission, and reverse reflection curves in the range of 400 to 700 nm for the filter arrangement of Table 7 are illustrated in FIGS. 32, 33, and 34, respectively.

As seen from the reflection curves for the image (R_{I}) and background (R_{B}) given in FIG. 32, the difference between the percentage of light reflected by the image and background is extremely high over the entire visible spectrum. Further, the contrast at 550 nm is extremely high. Thus, the filter arrangement given in Table 7 will exhibit extremely high contrast between the pattern and image portion over the entire visible spectrum.

The computed transmittance curves for the image (T_{I}) and background (T_{B}) are shown in FIG. 33. By reviewing the transmittance curves it is observed that the difference in the percentage of light transmitted through the background and the percentage of light transmitted through the image varies by over 5% over a substantial portion of the region of 480 nm to 630 nm. As a result, the pattern produced by the filter arrangement of Table 7 will be visible in transmission. Therefore, the filter arrangement given by Table 7 is unacceptable without further modification.

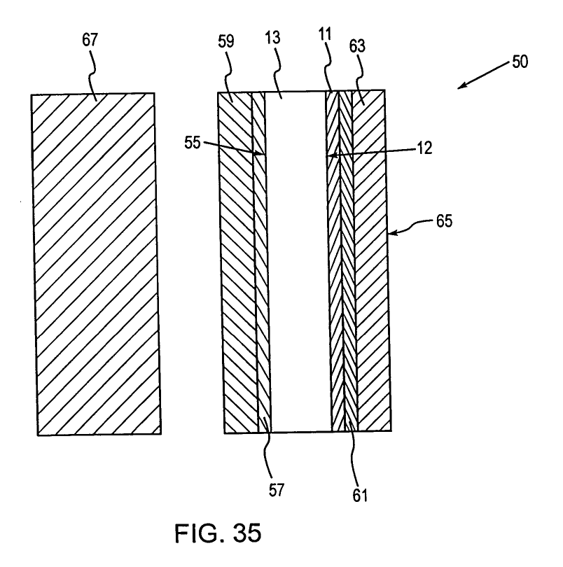

By changing the entrance medium to match the exit medium, i.e. by adding another layer of PET film to the top of stack 11 in the construction shown in FIG. 23, a filter arrangement having superior qualities is produced. The general construction of such a filter arrangement is illustrated in FIG. 35.

The filter arrangement 50 of FIG. 35 comprises a flexible film substrate 13 having a first side 12 and a second side 55. A mounting adhesive 57 is applied to the second side 55, and a removable release liner 59 is removably attached thereto. The first side 12 of substrate 51 is coated with a multi-layer stack 11 of metals and dielectrics. Stack 11 may correspond to any one of the configurations illustrated in FIGS. 1, 7, 16, 21, 22, and 23. Preferably, however, stack 11 corresponds to a construction illustrated in FIG. 23. Following the deposition of stack 11 on substrate 13, a laminating adhesive layer 61 is preferably applied over the stack 11 and a protective film 63 is then laminated to the substrate using adhesive layer 61.

Flexible film substrate 13 may be a standard polyester or PET film used in the window film art. Typically substrate 13 will have a thickness of 25 to 250 μm and may be clear or dyed. Preferably, however, it is optically pure. If filter arrangement 50 is to be exposed to UV rays, it may be desirable to include UV absorbers in substrate 13.

Mounting adhesive 57 may be any of the standard mounting adhesives used in the window film art, including, for example, pressure sensitive adhesives, detackified pressure sensitive adhesives, and water activated adhesives. Similarly, any of the known laminating adhesives may be used for laminating adhesive layer 61. Mounting adhesive 57 and laminating adhesive 61 are preferably optically pure to ensure that the optical characteristics of the filter arrangement are not degraded. Further, the refractive index of the adhesive should be as close as possible to the substrate 13 in the case of mounting adhesive 57 and protective film 63 in the case of the laminating adhesive to minimize reflections at these interfaces. However, because the adhesives are typically 6 μm to 13 μm thick they will not typically cause any interference patterns to be produced with respect to the light reflected, transmitted, or reverse reflected from the background and image portions of stack 11. Preferably UV absorbers are included in the mounting and laminating adhesives if the filter arrangement is to be exposed to sunlight.

Protective film 63 is typically a 25 to 100 μm optically pure polyester or PET film, which preferably includes a scratch resistant coating on surface 65.

A suitable polymeric scratch resistant coating may also be substituted for adhesive layer 61 and protective layer 63. Optically clear ultraviolet cured scratch resistant coatings used in the window film art are suitable for this purpose.

Removable release liner 59 is preferably a silicone coated clear polyester release liner of the type typically used in the window film art.

Filter arrangement 50 may be laminated to a wide variety of substrates 67 using standard techniques known in the window film industry. As those skilled in the art will appreciate, however, the actual technique used to install filter arrangement 50 will depend on the mounting adhesive used. Because release liner 59 is discarded during the installation process, release liner 59 does not form a part of filter arrangement 50 and will not effect the optical properties of the final filter arrangement 50.

Substrates 67 may include any of the substrates previously described. Further, filter arrangements 50 are particularly well suited for the large format applications descried below. Filter arrangement 50 is also particularly useful in smaller format applications such as helmet visors and the like. This is because a large number of filter arrangements 50 may be deposited on a single flexible substrate 13. The filter arrangements 50 may then be spliced from one another and attached to the desired substrates 67, e.g., helmet visors. This approach allows for substantially increased production rates over current batch-type coating processes known in the art.

Table 8 below lists the layer thicknesses for a stack 11 of a filter arrangement having the construction illustrated in FIG. 35 and having a stack configuration according to FIG. 23 deposited thereon. The five layers making up the stack 11 are conveniently designated the first through fifth, beginning with the first metal layer 15 disposed on the substrate 13.

TABLE 8

| Layer No. | Material | Thickness (nm) |
|---|---|---|
| Substrate | PET Film | |
| 1 | Cr | 0.77 |
| 2 | ITO | 60 |
| 3 | Cr | 2.5 |
| 4 | ITO | 60 |
| 5 | ITO | 0.3 |
| Entrance Medium | PET Film | |

Thus, the filter arrangement of Table 8 is the same as that of Table 7, except that the entrance medium has been changed to a PET film, so that the entrance and exit mediums of the filter arrangement are the same on both sides of the filter arrangement.

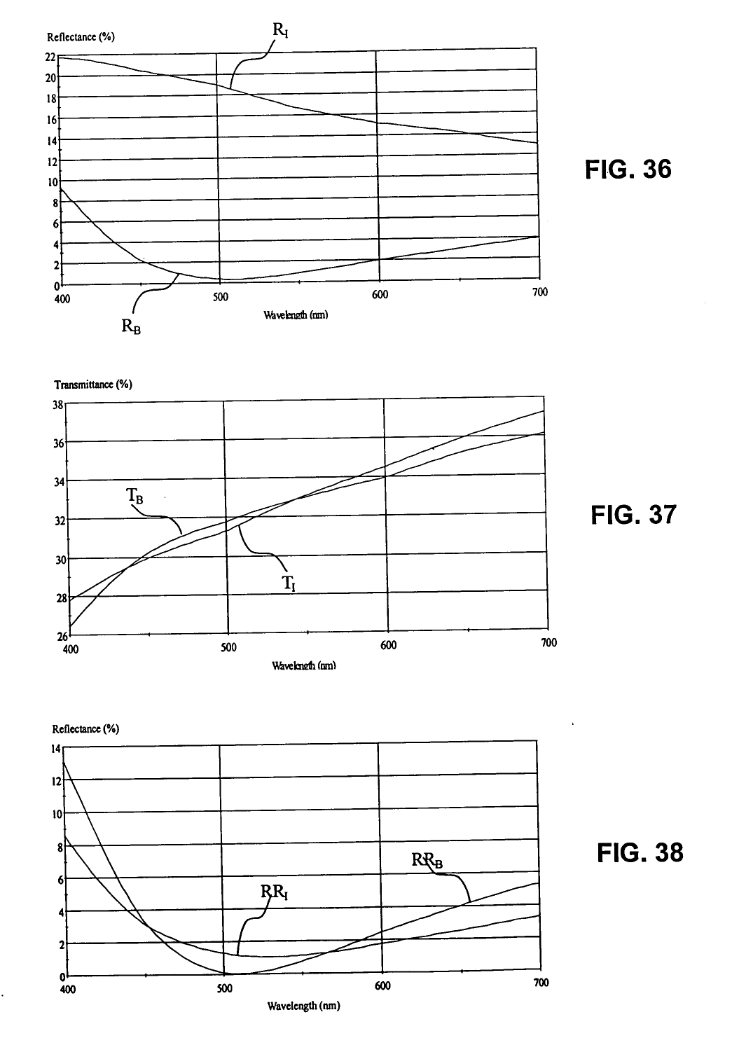

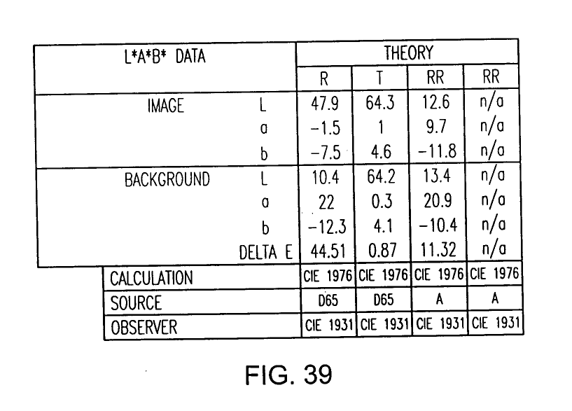

The computed reflection, transmission, and reverse reflection curves in the range of 400 to 700 nm for the filter arrangement of Table 8 are illustrated in FIGS. 36, 37, and 38, respectively, and the theoretical ΔE values between the image and background area pattern reflectance, transmission and reverse reflectance are shown in FIG. 39.

As seen from the reflection curves for the image (R_{I}) and background (R_{B}) given in FIG. 36, the difference between the percentage of light reflected by the image and background remains extremely high over the entire visible spectrum even after changing the entrance medium to a PET film. However, the overall level of reflectance is less than that of the filter arrangement given in Table 7. This is to be expected, however, because the index of refraction of the PET film is close to that for glass and thus greater than that for air. The contrast at 550 nm for the filter arrangement is approximately 0.92, and the theoretical ΔE calculation for the pattern reflectance yields a value of 44.51 as shown in FIG. 39. Thus, the filter arrangement given in Table 8 will exhibit extremely high contrast between the pattern and image portion over the entire visible spectrum, and will thus result in a pattern having very high visibility.

Reviewing the computed transmittance curves for the image (T_{I}) and background (T_{B}) shown in FIG. 37 it is observed that the overall percentage transmittance of the filter construction is generally greater than 30% over the majority of the visible spectrum. Accordingly, the filter arrangement of Table 8 is suitable for applications where high transmissibility is desired, such as for arena sky box windows. It is also observed from reviewing the transmission curves that the difference in the percentage of light transmitted through the background and the percentage of light transmitted through the image varies by less than about 1% over the region of 480 nm to 630 nm, and less than 2% over the entire 400 to 700 nm range. Thus, the pattern produced by filter arrangements of Table 8 will be substantially imperceptible when viewed in transmission through the filter arrangement. This is generally confirmed by the theoretical ΔE calculation for the pattern transmission, which yields an extremely low value of 0.87.

From the computed reverse reflectance curves shown in FIG. 38, it can be seen that the difference between the percentage of light reflected from the image (RR_{I}) and percentage of light reflected from the background (RR_{B}) regions of the filter arrangement from the substrate side is less than 2% over a the range of 480 to 630 nm. In addition, balance exists at 550 nm. Thus, while the theoretical ΔE value of 11.32 calculated for the pattern reverse reflectance appears high, the pattern produced by a filter arrangement according to Table 8 will be substantially imperceptible in reverse reflection. This especially true in view of the fact that the overall reverse reflection is less than 13% over the entire visible spectrum, and less than 4% over the range of 480 nm to 630 nm. Thus, the filter arrangement given in Table 8 is ideally suited for applications involving any back lighting conditions.

The foregoing example illustrates that the final performance of the design of any optical filter arrangement according to the present invention must take into account the optical characteristics of both the entrance and exit mediums that are intended to be employed in conjunction with the filter arrangement.

It will be evident to those skilled in the optical interference filter design art that many layer thickness combinations are possible for the various embodiments of filter arrangements disclosed herein. Having appreciated the principles above, one skilled in the optical interference filter design art, using commercially available computation aides, may readily determine any number of examples of the present invention to satisfy particular reflection, transmission, and reverse reflection objectives.

The optical filter arrangements of the present invention have numerous possible applications, including, for example:

the windscreens and windows of motor vehicles, locomotives, airplanes, boats and any other form of land, sea and air transport;

visors for helmets and the like and sunglasses;

all forms of architectural glass, including windows, shop fronts, sliding doors and advertising panels;

optical lenses and filters used in cameras, telescopes, binoculars and the like;

skybox windows for sports arenas and racetracks; and

compact disks and digital video disks.

The filter arrangements described above may be manufactured in a host of ways using known methods of depositing metal and dielectric thin films on a substrate. In general, however, the stacks 11 may be deposited on substrate 13 by first depositing the common metal and dielectric layers of stacks 11a and 11b using one of several different methods that are well known in the art such as physical vapor deposition (PVD), ion-assisted PVD, chemical vapor deposition, evaporation, sputtering, magnetron sputtering, and chemical spraying or dipping processes. A removable mask layer is then applied to block the image (or background as the case may be) from further coating. Next, the additional dielectric and metal layers needed to complete stack 11b are deposited to their desired thicknesses. Finally, the mask layer is removed.

It will be appreciated that if more than two colors are desired in the pattern produced by the filter arrangement, a second masking operation may be performed prior to removal of the first mask. Additional dielectric or metal layers may then be deposited, in essence producing a third sub stack within stack 11. Once all of the layers are deposited, the masking from the first and second masking operations is removed.

A particularly preferred method of manufacturing the filter arrangements described herein on a flexible film substrate is now described.

For many applications, it will be desirable to manufacture the filter arrangements herein described in large quantities to achieve economies of scale that can provide product to a mass market. For other applications, an economical way of providing both standard and custom large format filter arrangements will be desirable. The method described herein permits a wide variety of filter arrangement designs as well as sizes to be produced on a commercially viable basis.

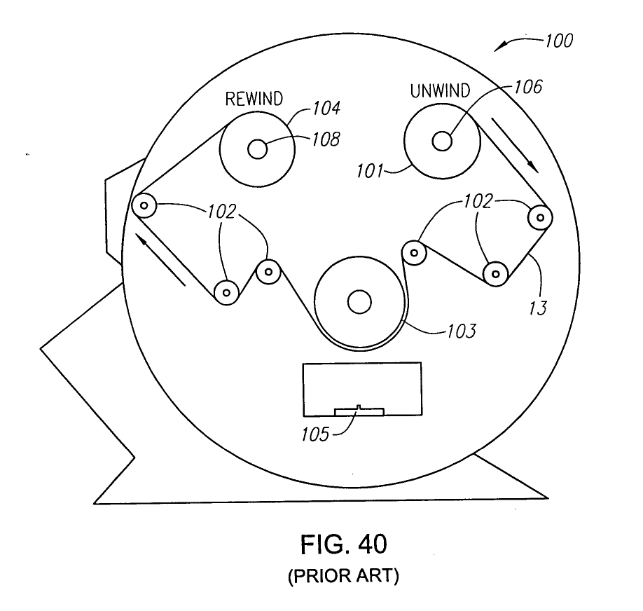

To achieve the desired economies of scale, the filter arrangement is produced on a flexible film substrate 13, provided as a roll 101 wound around a core. A standard web coater 100, as shown in FIG. 40, may then be used to deposit the optical thin films that make up stack 11.

The flexible film substrate 13 is preferably greater than 0.3 m wide, with a linear length greater than approximately 3 m. However, in order to achieve desired mass productions and satisfy the needs of large format applications, the film substrate 13 is preferably at least 2 to 3 m wide and has a linear length greater than 50 m. The width of the substrate 13 used is dependent upon the capacity of the web coater used, as most web coaters are designed to work with substrates of specific widths. Similarly, the length of substrate 13 is only limited by the diameter of roll 101 that the web coater 100 may accept.

Substrate 13 may be a polyester or PET film, or other polymer film. Polymer films of the type used in the window film art are particularly well suited to for the construction of the filter arrangements according to the present invention using the present method. Substrate 13 may also advantageously include mounting adhesive 57 and release liner 59 attached to surface 55 of the substrate.

Mounting adhesive 57 and release liner 59 are typically included if substrate 13 is to be laminated to another substrate 67 following construction of the filter arrangement. However, it is also possible to apply a mounting adhesive after the deposition of stack 11 on substrate 13.

Rolls 101 of the flexible film substrate 13 are typically provided on a cardboard core from the manufacturers of the film. Depending upon the web coater 100 used, the substrate 13 may need to be transferred to a core useable in the web coater 100. Once the substrate is on a suitable core, the roll 101 may be loaded into the web coater.

FIG. 40 illustrates a web coater 100 having a roll 101 of flexible film substrate 13 loaded within. The roll 101 is mounted on a first spindle 106, the substrate is threaded through a plurality of rollers 102, including a plating drum 103, and the end of the substrate is attached to a second spindle 108. The substrate is exposed to the deposition source 105 at a point where the substrate passes over the plating drum 103. The deposition source 105 may be a sputter deposition source, thermal evaporation source, or a source for any other physical vapor deposition technique known in the art. Sputtering, however, is the preferred method for depositing the thin films as herein described. Sputtering has the advantage of permitting the process to be at least partially automated because important deposition parameters, namely the rate, power, and pressure, are well controlled and understood, and therefore, the thin films making up multi-layer thin film stacks 11 may be deposited in a reproducible manner. Sputtering is also advantageous because heat-sensitive film substrates can be coated without damage to the film substrate. Coatings produced by the sputtering process also tend to have greater durability and more consistent optical properties.

Once the roll 101 is loaded into the web coater 100 and the substrate is properly threaded, a base stack may be deposited one thin film layer at a time over a substantial majority of the length and width of the substrate. In depositing a thin film layer, the substrate 13 is unwound from roll 101 on the first spindle 106 and wound onto the second spindle 108 to form a rewind roll 104. As the substrate passes by the deposition source 105, a thin film layer is deposited by deposition source 105.

The rate at which roll 101 is unwound from spindle 106 to take up spindle 108, will depend on a variety of factors well known in the art, including the material being deposited, the thickness to be deposited, and the physical vapor deposition process being employed. For sputtering, the deposition parameters further include, for example, the chamber pressure and background gas composition, target voltage, applied or assumed biases, current density, plasma voltage, and system geometry. As a result, it is typical in the art to develop calibration curves for each material to be deposited. These calibration curves relate feed rates to coating thickness for a particular set of system parameters and material being deposited. Because each machine is slightly different, calibration curves tend to be machine specific, particularly when depositing optical thin films of the thickness employed in the stacks of the present invention. However, as the method of producing such calibration curves is well known in the art, a detailed discussion is not required here. It will be appreciated, however, that variations tend to occur in coaters over time, and thus periodic recalibration of the coater 100 is desirable. Constant monitoring of the coating process, with adjustments being made as necessary, should also be practiced to ensure that the desired thickness of a particular thin film is being deposited.

Following the deposition of the first thin film, the substrate 13 is completely wound on the second spindle 108 and forms roll 104. At this point, depending upon the particular web coater used, the substrate 13 may need to be rewound onto the first spindle 106. If the substrate 13 does not need to be rewound, then the second thin film layer is deposited as the substrate is rewound onto the first spindle 106. Otherwise, the second thin film layer is deposited by the same process used to deposit the first thin film layer after the substrate 13 is rewound. The entire process is then repeated for the third thin film layer. If additional thin film layers form the base stack then the process is repeated the appropriate number of times, each time using a target and process parameters appropriate for the material and thickness to be deposited.

The various thin film layers deposited to form the base stack will depend on the particular embodiment of the filter arrangement of the present invention being produced. In general, however, the base stack comprises those layers that form stack 11a in the embodiments illustrated in FIGS. 1, 7, 16, and 21-23. Thus, for example, in the filter arrangement illustrated in FIG. 1, the first three layers form the base stack.

Therefore, to produce the optical filter arrangement illustrated in FIG. 1, the first metal thin film is the first thin film layer deposited as the substrate 13 is wound from the first spindle 106 to the second spindle 108. Assuming the substrate 13 needs to be rewound, the second thin film layer, being the first dielectric layer in FIG. 1, is deposited as the substrate again is unwound from the first spindle 106 to the second spindle 108. The substrate 13 is once again rewound and the third thin film layer, being the second metal thin film in FIG. 1, is deposited as the substrate 13 again is unwound from the first spindle 106 to the second spindle 108. Thus, the base stack is formed on the substrate. It will be appreciated that the order and number of layers deposited to form the base stack will depend on the particular embodiment of the invention being produced.

Once the base stack is deposited on the substrate, the process may continue to complete one or more optical filter arrangements on substrate 13. Alternatively, the substrate 13 having the base stack thereon may be stored for an indefinite period of time. Preferably, the substrate 13 is stored in a controlled environment to minimize potential for damage to the base stack. In this regard, it may be advantageous to employ a filter arrangement that has a dielectric layer as a final layer of the basic stack as the dielectric layer will provide added protection to the underlying metal layers, which may be more susceptible to oxidation.

The ability to store substrate 13 with a base stack thereon indefinitely without impeding the ability to complete the manufacturing process is a significant advantage in achieving a commercially viable process. In this manner, many rolls of substrate 13 may have a base stack deposited thereon during a single manufacturing run. Further, each roll may have a different base stack suitable for a particular image and background color combination, as well as particular reflection, transmission, and reverse reflection objectives. When a need arises for a particular filter arrangement, a section of substrate 13, a section being smaller than the entire roll, may then be removed from a stored roll 101 having the relevant base stack for the particular filter arrangement design of interest and used to complete the manufacturing process as described herein.

Once the base stack is deposited upon the substrate 13, a removable mask layer is printed over a portion of the base stack. The mask layer may comprise any printable graphic, design, logo, image, or word(s) as described above. The removable mask layer may be printed on substrate 13 using a wide format printer controlled by a microprocessor. The wide format printer is preferably an ink jet type printer, although printers using other print methods may also be used. It has been found that piezo based wide format digital printers that use solvent based inks are particularly well suited for depositing the mask layer. The microprocessor is preferably a commercially available graphic-capable computer that is capable of sending large format graphics to the printer. Using the wide format printer and the computer, the mask layer may be printed on an entire roll of substrate. One hundred and fifty linear meters or more of substrate may therefore be prepared during a single run of the printer, thus further enabling the mass production of an optical filter arrangement. Alternatively, if only a section of substrate is removed from a roll in storage, the mask layer may be printed on only that section. The manufacturing process may therefore be quickly completed on smaller sections of substrate, thus giving rise to the ability to rapidly fill orders using the large quantities of stored substrate upon which the base stack is already deposited. Both alternatives lend themselves well to achieving the desired economies of scale.

Further, the pattern deposited with the removable mask layer may correspond to a large number of individual filter arrangements that are subsequently spliced from the film after the completion of the coating process. This approach is particularly well suited for applications such as helmet visors and the like. This is because a large number of filter arrangements can be produced at one time and then subsequently laminated to the desired substrate 61 shown in FIG. 35. As a result, substantially increased production rates are possible.

With respect to custom large format filter arrangements, registration marks may be formed by depositing the mask layer in appropriate locations. These registration marks will be visible when the masking layer is removed and the filter arrangement completed. The registration marks may then be used to assist in the installation of filter arrangements that are wider than substrate 13 by allowing installers to properly align various portions of filter arrangement to produce the desired image.

The mask layer is printed onto the base stack using a removable masking material, preferably removable ink. U.S. Pat. No. 4,925,705, incorporated herein by reference, discloses several different types of inks and methods to remove said inks which may be easily adapted for the process of manufacturing an optical filter arrangement as described herein. The preferred ink has a high surface tension, provides consistent coverage when printed onto the base layer, is removable using an environmentally safe solvent, and is compatible with the print heads and other parts of the wide format printer. One ink that has been found suitable for use in practicing the present invention using a piezo based digital printer has been produced by Prism, Inc., located at 1430 Koll Circle, 109, San Jose, Calif., and it is supplied under the name Jax solvent based ink.

Once the mask layer is printed upon the base stack, the substrate is reinserted into the web coater where one or more thin film layers are deposited over the mask layer and the exposed portions of the base stack in order to complete stack 11b on the exposed portions of the base stack. Thus, the particular thin films deposited and the order in which they are deposited will depend on the particular embodiment of the filter arrangement of the present invention being produced. Where an entire roll is being processed to completion, the roll is loaded into the web coater in the manner previously described. Where only a section of the substrate is being processed to completion, the section is first wound on an appropriate core and then loaded into the web coater. The deposition of the one or more additional thin film layers then proceeds in the manner previously described. For example, to achieve the optical filter arrangement illustrated in FIG. 1, the additional layer, being the second dielectric layer, is deposited as the final thin film layer. To achieve the optical filter arrangement illustrated in FIG. 22, a first additional layer, being the third metallic layer in FIG. 22, is deposited. The substrate is then rewound as necessary and a second additional layer, being the second dielectric layer in FIG. 22, is deposited as the final thin film layer.

Once the final thin film layer is deposited, the substrate is removed from the web coater and the mask layer is removed to expose a completed optical filter arrangement. Depending upon the type of ink used, a solvent such as water, isopropyl alcohol, or any appropriate organic solvent may be required to remove the mask layer. For some types of inks, scrubbing may be required to completely remove the mask layer. Scrubbing, if needed, is done with a non-abrasive scrubber so as not to scratch the exposed thin films. As such, scrubbing is preferably done with a soft, 100% cotton pad when necessary.

Thus, an improved optical filter arrangement has been disclosed along with a method manufacturing such optical filter arrangements on flexible film substrates. While embodiments of the inventions have been shown and described, it will be apparent to those skilled in the art that many more modifications are possible without departing from the inventive concepts herein. The invention, therefore, is not to be restricted except in the spirit of the appended claims.

What is claimed is:

1. A multi-layer optical filter arrangement having spatially and spectrally differential reflection characteristics and substantially uniform transmission characteristics over a band of at least 250 nm in the optical spectrum, said filter arrangement comprising:
(a) a substrate having a surface, the substrate being at least semi-transparent over the majority of the band;
(b) a first stack of optical thin films deposited on the surface of the substrate, the first stack comprising two metal layers and a dielectric layer interposed therebetween; and
(c) a second stack of optical thin films deposited on the surface of the substrate in a contiguous side by side relationship with the first stack, the second stack including two metal layers and a dielectric layer interposed therebetween, the two metal layers and dielectric layer of the second stack being extensions of the layers in the first stack, the second stack further including a second dielectric layer deposited thereon;
(d) wherein the first and second stacks reflect substantially different spectrums of light within the band from a reflecting side of the filter arrangement and the filter arrangement has substantially uniform transmission characteristics.

2. A multi-layer optical filter arrangement according to claim 1, wherein the band includes at least a portion of one of the following optical spectrums: the near UV spectrum, the visible spectrum, and the near infrared spectrum.

3. A multi-layer optical filter arrangement according to claim 1, wherein the band is between 480 nm and 630 nm.

4. A multi-layer optical filter arrangement according to claim 1 having spectrally differential reflection characteristics and substantially uniform transmission characteristics over a band of at least 300 nm in the optical spectrum.

5. A multi-layer optical filter arrangement according to claim 4, wherein the band is between 400 nm and 700 nm.

6. A multi-layer optical filter arrangement according to claim 1 in which the first stack further comprises a third dielectric layer deposited thereon, the third dielectric layer being of a different thickness than the second dielectric layer of the second stack.

7. A multi-layer optical filter arrangement according to claim 1 having a transmission of at least 40% of the incident light over a majority of the band.

8. A multi-layer optical filter arrangement according to claim 1 having a transmission of at least 20% of the incident light over a majority of the band.

9. A multi-layer optical filter arrangement according to claim 1 in which the difference between the percentage of light transmitted through the first stack of the filter arrangement and the percentage of light transmitted through the second stack of the filter arrangement varies by less than or equal to 5% over the band.

10. A multi-layer optical filter arrangement according to claim 1 in which the difference between the percentage of light transmitted through the first stack of the filter arrangement and the percentage of light transmitted through the second stack of the filter arrangement varies by less than or equal to 3% over the band.

11. A multi-layer optical filter arrangement according to claim 1 in which the difference between the percentage of light transmitted through the first stack of the filter arrangement and the percentage of light transmitted through the second stack of the filter arrangement varies by less than or equal to 1% over the band.

12. A multi-layer optical filter arrangement according to claim 1 in which the difference between the percentage of light reflected from the first stack of the filter arrangement from the reflecting side and the percentage of light reflected from the second stack of the filter arrangement from the reflecting side varies by more than 5% over a substantial portion of the band.

13. A multi-layer optical filter arrangement according to claim 1 in which the difference between the percentage of light reflected from the first stack of the filter arrangement from the reflecting side and the percentage of light reflected from the second stack of the filter arrangement from the reflecting side varies by at least 10% over a substantial portion of the band.

14. A multi-layer optical filter arrangement according to claim 1 in which the difference between the percentage of light reflected from the first stack of the filter arrangement from the reflecting side and the percentage of light reflected from the second stack of the filter arrangement from the reflecting side varies by at least 25% over a substantial portion of the band.

15. A multi-layer optical filter arrangement according to claim 1 in which the difference between the percentage of light reflected from the first stack of the filter arrangement and the percentage of light reflected from the second stack of the filter arrangement when measured from the side opposite the reflecting side varies by less than or equal to 5% over the band.

16. A multi-layer optical filter arrangement according to claim 1 in which the difference between the percentage of light reflected from the first stack of the filter arrangement and the percentage of light reflected from the second stack of the filter arrangement when measured from the side opposite the reflecting side varies by less than or equal to 3% over the band.

17. A multi-layer optical filter arrangement according to claim 1 in which the difference between the percentage of light reflected from the first stack of the filter arrangement and the percentage of light reflected from the second stack of the filter arrangement when measured from the side opposite the reflecting side varies by less than or equal to 1% over the band.

18. A multi-layer optical filter arrangement according to claim 1 in which the percentage of light reflected from the first stack of the filter arrangement and the percentage of light reflected from the second stack of the filter arrangement when measured from the side opposite the reflecting side is less than or equal to 10% over substantially the entire band.

19. A multi-layer optical filter arrangement according to claim 1, wherein the substrate is a flexible substrate.

20. A multi-layer optical filter arrangement according to claim 19, wherein the substrate is a flexible film substrate comprised of a polymer selected from the group consisting of polyesters, PET, polycarbonate, acrylic, and cellulose triacetate.

21. A multi-layer optical filter arrangement according to claim 1, wherein the metal layers comprise at least one metal selected from the group consisting of chromium, nichrome, inconel, molybdenum, nickel, tungsten, rhodium, titanium, and vanadium.

22. A multi-layer optical filter arrangement according to claim 1, wherein the dielectric layers comprise at least one dielectric selected from the group consisting of silicon monoxide, titanium dioxide, tantalum pentoxide, yttrium oxide, neodymium oxide, niobium oxide, indium tin oxide, indium zinc oxide, zirconium oxide.

23. A method of manufacturing an optical filter arrangement on a roll of flexible film substrate that is at least two feet wide comprising:
(a) depositing a multi-layer thin film base stack on a surface of said substrate and over a substantial majority of its length using a web coater;
(b) printing a mask layer over a portion of said base stack using a wide format printer, said mask layer comprising a removable ink;
(c) depositing at least one additional thin film layer over said base stack and mask layer using the web coater; and
(d) removing said mask layer.

24. The method of claim 23, wherein said base stack comprises a first metallic thin film layer deposited on said substrate, a first dielectric thin film layer deposited on said first metallic layer, and a second metallic thin film layer deposited on said first dielectric layer.

25. The method of claim 23, wherein said additional thin film layer comprises a dielectric thin film layer.

26. The method of claim 23, wherein said wide format printer comprises a raster printer.

27. The method of claim 23, wherein step (b) further comprises connecting said printer to a microprocessor and utilizing said microprocessor to print said mask layer in the form of an image file stored within said microprocessor.

28. The method of claim 23, wherein said mask layer is removed using a solvent.

29. The method of claim 28, wherein said solvent is water.

30. The method of claim 28, wherein said solvent is an organic solvent.

31. The method of claim 28, wherein said solvent is isopropyl alcohol.

32. A method of manufacturing an optical filter arrangement on a roll of flexible film substrate that is at least two feet wide comprising:
(a) depositing a multi-layer thin film base stack on a surface of said substrate and over a substantial majority of its length using a web coater;
(b) storing said substrate for an indeterminate period of time;
(c) removing a section of said substrate as needed;
(d) printing a mask layer over said base stack on a portion of said section using a wide format printer, said mask layer comprising a removable ink;
(e) depositing at least one additional thin film layer over said base stack and mask layer of said section using the web coater; and
(f) removing said mask layer.

33. The method of claim 32, wherein said base stack comprises a first metallic thin film layer deposited on said substrate, a first dielectric thin film layer deposited on said first metallic layer, and a second metallic thin film layer deposited on said first dielectric layer.

34. The method of claim 32, wherein said additional thin film layer comprises a dielectric thin film layer.

35. The method of claim 32, wherein said wide format printer comprises a raster printer.

36. The method of claim 32, wherein step (b) further comprises connecting said printer to a microprocessor and utilizing said microprocessor to print said mask layer in the form of an image file stored within said microprocessor.

37. The method of claim 32, wherein said mask layer is removed using a solvent.

38. The method of claim 37, wherein said solvent is water.

39. The method of claim 37, wherein said solvent is an organic solvent.

40. The method of claim 37, wherein said solvent is isopropyl alcohol.
